(19) United States
(12) Patent Application Publication
(10) Pub. No.: US 2024/0424393 A1
(43) Pub. Date: Dec. 26, 2024

(54) VIRTUAL WORLD-BASED CHARACTER INTERACTION METHOD AND APPARATUS, DEVICE, AND MEDIUM

(71) Applicant: Tencent Technology (Shenzhen) Company Limited, Shenzhen (CN)

(72) Inventor: Xinping LI, Shenzhen (CN)

(21) Appl. No.: 18/828,905

(22) Filed: Sep. 9, 2024

Related U.S. Application Data
(63) Continuation of application No. PCT/CN2023/130305, filed on Nov. 7, 2023.

(30) Foreign Application Priority Data
Dec. 16, 2022 (CN) 202211627922.6

(51) Int. Cl. A63F 13/52

(52) U.S. Cl. CPC A63F 13/52

(57) ABSTRACT

This application discloses a virtual world-based character interaction method performed by a computer device. The method includes: displaying a first virtual character in a physical state in a first virtual world; in response to a first control operation on the first virtual character, controlling the first virtual character to perform physical interaction with a world element in the physical state in the first virtual world and updating the world element in the first virtual world in accordance with the physical interaction; displaying a second virtual character in a ghost state in the first virtual world, the second virtual character being a character in a second virtual world controlled by a second computer device; and in response to a second control operation on the first virtual character by the user of the computer device, controlling the first virtual character to perform non-physical interaction with the second virtual character.

### CROSS-REFERENCE TO RELATED APPLICATIONS

This application is a continuation application of PCT Patent Application No. PCT/CN2023/130305, entitled “VIRTUAL WORLD-BASED CHARACTER INTERACTION METHOD AND APPARATUS, DEVICE, AND MEDIUM” filed on Nov. 7, 2023, which claims priority to Chinese Patent Application No. 202211627922.6, entitled “VIRTUAL WORLD-BASED CHARACTER INTERACTION METHOD AND APPARATUS, DEVICE, AND MEDIUM” and filed on Dec. 16, 2022, both of which are incorporated herein by reference in their entirety.

### FIELD OF THE TECHNOLOGY

Embodiments of this application relate to the field of human-computer interaction, and in particular, to a virtual world-based character interaction method and apparatus, a device, and a medium.

### BACKGROUND OF THE DISCLOSURE

A single-player game, also referred to as a single player game, is a game that can be independently run through only one computer or another electronic device.

In a single-player game in a virtual world background in the related art, a player generally interacts with a non-player character (NPC) in the same virtual world or some world elements forming the virtual world.

However, in the related art, the player has a relatively undiversified interaction manner.

### SUMMARY

This application provides a virtual world-based character interaction method and apparatus, a device, and a medium. The technical solutions are as follows:

According to an aspect of this application, a virtual world-based character interaction method is performed by a computer device, the method including:
displaying a first virtual character in a physical state in a first virtual world;
in response to a first control operation on the first virtual character by a user of the computer device, controlling the first virtual character to perform physical interaction with a world element in the physical state in the first virtual world and updating the world element in the first virtual world in accordance with the physical interaction;
displaying a second virtual character in a ghost state in the first virtual world, the second virtual character being a character in a second virtual world controlled by a second computer device; and
in response to a second control operation on the first virtual character by the user of the computer device, controlling the first virtual character to perform non-physical interaction with the second virtual character, wherein no physical interaction is performed on the second virtual character in the first virtual world and a physical interaction is performed on the second virtual character in the second virtual world during the non-physical interaction.

According to another aspect of this application, a virtual world-based character interaction method is provided, performed by a server, the method including:
transmitting, when a first virtual character is in an online state, a world element of a first virtual world corresponding to the first virtual character to a first client;
determining a second virtual character, the second virtual character being a virtual character located in a second virtual world; and
transmitting character synchronization data of the second virtual character to the first client, to enable the first client to display the second virtual character in a ghost state in the first virtual world and control the first virtual character to perform non-physical interaction with the second virtual character, no physical interaction being performed by the second virtual character with the world element in the first virtual world during the non-physical interaction.

According to another aspect of this application, a computer device is provided, including a processor and a memory, the memory having a computer program stored therein, and the computer program being loaded and executed by the processor and causing the computer device to implement the virtual world-based character interaction method described above.

According to another aspect of this application, a non-transitory computer-readable storage medium is provided, having a computer program stored therein, and the computer program being loaded and executed by a processor of a computer device and causing the computer device to implement the virtual world-based character interaction method described above.

According to another aspect of this application, a computer program product is provided, including computer instructions, the computer instructions being stored in a computer-readable storage medium, and a processor obtaining the computer instructions from the computer-readable storage medium, to cause the processor the load and execute the computer instructions to implement the virtual world-based character interaction method described above.

According to the method provided in embodiments of this application, not only physical interaction between a player in an individual virtual world with a world element can be implemented, but also non-physical interaction between the player in the individual virtual world with another player in another virtual world can be implemented, thereby enriching interaction manners between players. By using the method provided in the embodiments of this application, compared with a single-player game, the player can interact with a real person, thereby weakening the loneliness of the single-player game. Compared with a multiplayer game, by constructing virtual worlds of different players and using a representation form of a ghost, the second virtual character does not interfere with a game process of the first virtual character, so that mutual interference and resource preemption between players of the multiplayer game are weakened, thereby increasing the immersed feeling of game experience and improving the game experience of the players.

In addition, during the non-physical interaction between the first virtual character in the physical state and the second virtual character in the ghost state, since the second virtual character does not need to perform physical interaction with the world element in the first virtual world, there is no need to additionally calculate data generated by interaction between the second virtual character and the world element. Therefore, a calculation amount during character interaction can be reduced, helping reduce processing pressure during character interaction.

### BRIEF DESCRIPTION OF THE DRAWINGS

FIG. 1 is a structural block diagram of a computer system according to an exemplary embodiment.

FIG. 2 is a schematic diagram of a virtual world according to an exemplary embodiment.

FIG. 3 is a schematic diagram of a virtual world according to another exemplary embodiment.

FIG. 4 is a flowchart of a virtual world-based character interaction method according to an exemplary embodiment.

FIG. 5 is a flowchart of a virtual world-based character interaction method according to another exemplary embodiment.

FIG. 6 is a schematic diagram of controlling a first virtual character to perform a target action in a first virtual world according to an exemplary embodiment.

FIG. 7 is a schematic diagram of controlling a second virtual character to perform a target action in a second virtual world according to an exemplary embodiment.

FIG. 8 is a schematic diagram of controlling a first virtual character to perform a target action in a first virtual world according to an exemplary embodiment.

FIG. 9 is a flowchart of a virtual world-based character interaction method according to an exemplary embodiment.

FIG. 10 is a schematic diagram of controlling a first virtual character to chat with a second virtual character according to an exemplary embodiment.

FIG. 11 is a schematic diagram of controlling a first virtual character to chat with a second virtual character according to an exemplary embodiment.

FIG. 12 is a schematic diagram of controlling a first virtual character to chat with a second virtual character according to an exemplary embodiment.

FIG. 13 is a schematic diagram of controlling a first virtual character to form a team with a second virtual character according to an exemplary embodiment.

FIG. 14 is a schematic diagram of controlling a first virtual character to form a team with a second virtual character according to an exemplary embodiment.

FIG. 15 is a schematic diagram of controlling a first virtual character to form a team with a second virtual character according to an exemplary embodiment.

FIG. 16 is a schematic diagram of controlling a first virtual character to exit a team according to an exemplary embodiment.

FIG. 17 is a flowchart of a virtual world-based character interaction method according to an exemplary embodiment.

FIG. 18 is a schematic diagram of region switching according to an exemplary embodiment.

FIG. 19 is a flowchart of a virtual world-based character interaction method according to an exemplary embodiment.

FIG. 20 is a flowchart of a virtual world-based character interaction method according to an exemplary embodiment.

FIG. 21 is a schematic diagram of determining a second virtual character belonging to the same character group as a first virtual character according to an exemplary embodiment.

FIG. 22 is a schematic diagram of ghost construction according to an exemplary embodiment.

FIG. 23 is a schematic diagram of ghost movement battle synchronization according to an exemplary embodiment.

FIG. 24 is a flowchart of a virtual world-based character interaction method according to an exemplary embodiment.

FIG. 25 is a schematic diagram of region switching according to an exemplary embodiment.

FIG. 26 is a schematic diagram of interaction between an individual virtual world and a multiplayer virtual world according to an exemplary embodiment.

FIG. 27 is a flowchart of migration from an individual virtual world to a multiplayer virtual world according to an exemplary embodiment.

FIG. 28 is a structural block diagram of a virtual world-based character interaction apparatus according to an exemplary embodiment.

FIG. 29 is a structural block diagram of a virtual world-based character interaction apparatus according to another exemplary embodiment.

FIG. 30 is a structural block diagram of a computer device according to an exemplary embodiment.

FIG. 31 is a structural block diagram of a computer device according to another exemplary embodiment.

### DESCRIPTION OF EMBODIMENTS

To make the objectives, technical solutions, and advantages of this application clearer, the following further describes implementations of this application in detail with reference to the accompanying drawings.

Exemplary embodiments are described in detail herein, and the embodiments are illustratively shown in the accompanying drawings. When the following descriptions relate to the accompanying drawings, unless otherwise indicated, same numbers in different accompanying drawings represent same or similar elements. The implementations described in the following exemplary embodiments do not represent all implementations consistent with this application. On the contrary, the implementations are merely examples of apparatuses and methods that are described in detail in the appended claims and that are consistent with some aspects of this application.

In this application, a prompt interface or a pop-up window may be displayed or voice prompt information may be outputted before and during collection of relevant data of a user. The prompt interface, the pop-up window, or the voice prompt information is configured for prompting the user that the relevant data of the user is currently being collected. In this application, only after a confirm operation performed by the user on the prompt interface or the pop-up window is obtained, a relevant operation of obtaining the relevant data of the user starts to be performed. Otherwise (that is, when the confirm operation performed by the user on the prompt interface or the pop-up window is not obtained), the relevant operation of obtaining the relevant data of the user ends, that is, the relevant data of the user is not obtained. In other words, all user data collected in this application is collected with user consent and authorization, and collection, use, and processing of relevant user data need to comply with relevant laws, regulations, and standards of relevant countries and regions.

First, terms involved in the embodiments of this application are briefly introduced:

Virtual world: It is a virtual world displayed or provided by an application program (a client) during running. The virtual world may be a simulated environment of a real world, or may be a semi-simulated and semi-fictional environment, or may be an entirely fictional environment. The virtual world may be any one of a two-dimensional virtual world, a 2.5-dimensional virtual world, or a three-dimensional virtual world, which is not limited in this application.

In the embodiments of this application, a plurality of players correspond to a plurality of virtual worlds, each player corresponds to an individual virtual world of the player, and the plurality of virtual worlds of the plurality of players are parallel worlds. Virtual worlds of different players include the same world elements and world resources during initialization. At least one of world element changes, world resource changes, and game progresses in the virtual worlds of different players do not interfere with each other. Therefore, the virtual world in the embodiments of this application is also referred to as an infinite world.

World element: It refers to various virtual elements appearing in the virtual world, which are configured for constituting the entire virtual world. The world element includes plots, lakes, the sky, various virtual animals, various virtual plants, various virtual buildings, and the like. A virtual character controlled by the player also belongs to one of world elements.

World resource: It is a world element that can be used by the virtual character controlled by the player in the virtual world. The world resource includes a virtual gold coin, a virtual item, a virtual treasure box, a virtual collection object, a virtual drop, and the like.

First virtual world: It is an individual virtual world provided for a first player or a first virtual character during running of a first client. The first virtual world includes various first world elements in a physical state.

For example, a world element in a physical state refers to an element that has a shape and a volume in the physical state in the first virtual world, and occupies a part of space in the first virtual world, which includes a plot, a virtual animal, a virtual plant, a virtual building, and the like.

physical state: It refers to a display form in which a world element has a collision size in a virtual world. When the world element comes into contact with another world element in the physical state, at least one change of collision deformation and collision displacement is produced. When a virtual character is in the physical state, the virtual character can perform physical interaction with a world element in the virtual world. Since all world elements are implemented by using three-dimensional models, the physical interaction may also be understood as interaction between two three-dimensional models having a collision size.

Second virtual world: It is an individual virtual world provided for a second player or a second virtual character during running of a second client. The second virtual world includes various second world elements in a physical state. In some embodiments, during initialization, an element type, a quantity, a position, a color, a form, and the like corresponding to the second world element in the second virtual world are the same as those corresponding to the first world element in the first virtual world.

For example, the first virtual world and the second virtual world are parallel worlds, and the first virtual world and the second virtual world do not interfere with each other. For example, the first player performs a position movement operation on the first world element in the first virtual world, but does not affect a position of the same second world element in the second virtual world of the second player.

When the first virtual character appears in a virtual world other than the first virtual world, or the second virtual character appears in a virtual world other than the second virtual world, the first virtual character or the second virtual character is displayed in a ghost state by default.

Ghost state: It refers to a display form in which a virtual character does not have a collision size in a virtual world. When the virtual character comes into contact with another world element in the physical state, none change of collision deformation and collision displacement is produced. When a virtual character is in the ghost state, the virtual character cannot perform physical interaction with a world element in the virtual world.

Multiplayer virtual world: It is a common virtual world in which different players or different virtual characters can all exist together. In the multiplayer virtual world, all different virtual characters are displayed in a physical state.

In some embodiments, in the multiplayer virtual world, physical interaction may be performed between different virtual characters. For example, the physical interaction includes at least one of interactive behaviors such as battling, handshaking, collaboration, or the like.

In some embodiments, the multiplayer virtual world is also referred to as a multiplayer region.

First virtual character: It is a movable object played or controlled by the first player in the first virtual world, and is a character controlled by the first player in the first virtual world by using the first client. The first virtual character may be a virtual person, a virtual animal, a cartoon person, or the like, for example, a person or an animal displayed in the first virtual world.

The first virtual character is in a physical state in the first virtual world of the first player, and the first virtual character is in a ghost state in the second virtual world of the second player.

In some embodiments, in the first virtual world, the first virtual character is a three-dimensional model in a physical state created based on a skeletal animation technology. The first virtual character has a shape and a volume in the physical state in the first virtual world, and occupies a part of space in the first virtual world.

In some embodiments, in the second virtual world, the first virtual character is a three-dimensional model in a ghost state created based on the skeletal animation technology. The first virtual character only has a shape in the ghost state in the second virtual world, where the shape in the ghost state is only configured for display, has no volume, and does not occupy space in the second virtual world. The second virtual character in the physical state in the second virtual world can directly pass through the first virtual character without any obstruction.

Second virtual character: It is a movable object played by the second player in the second virtual world, and is a character controlled by the second player in the second virtual world by using the second client. The first player and the second player are different players. The second virtual character may be a virtual person, a virtual animal, a cartoon person, or the like, for example, a person or an animal displayed in the second virtual world.

The second virtual character is in a ghost state in the first virtual world of the first player, and the second virtual character is in a physical state in the second virtual world of the second player.

In some embodiments, in the first virtual world, the second virtual character is a three-dimensional model in a ghost state created based on a skeletal animation technology. The second virtual character only has a shape in the ghost state in the first virtual world, where the shape in the ghost state is only configured for display, has no volume, and does not occupy space in the first virtual world. The first virtual character in the physical state in the first virtual world can directly pass through the second virtual character without any obstruction.

In some embodiments, in the second virtual world, the second virtual character is a three-dimensional model in a physical state created based on a skeletal animation technology. The second virtual character has a shape and a volume in the physical state in the second virtual world, and occupies a part of space in the second virtual world.

Third virtual character: It is a movable object played by a third player in the multiplayer virtual world, and is a character controlled by the third player in the multiplayer virtual world by using a third client. The third player generally refers to one or more players other than the first player. The third virtual character is a virtual character in the multiplayer virtual world, and the third virtual character is displayed in a physical state.

Target region: It refers to one or more specific regions in the individual virtual world of each player, and is a region that allows different virtual characters to switch from respective individual virtual worlds to the multiplayer virtual world, and perform physical interaction with world elements in the multiplayer virtual world.

Multiplayer region: It refers to one or more specific regions in the individual virtual world of each player, and is a region corresponding to the multiplayer virtual world.

In some embodiments, in the first virtual world, when the second virtual character in the ghost state initiates an interaction requirement to the first virtual character in the physical state, and the first virtual character performs an agree operation on the interaction requirement, the second virtual character may be transformed from the ghost state to the physical state.

In some embodiments, in the second virtual world, when the first virtual character in the ghost state initiates an interaction requirement to the second virtual character in the physical state, and the second virtual character performs an agree operation on the interaction requirement, the first virtual character may be transformed from the ghost state to the physical state.

In some embodiments, the interaction requirement includes at least one of a chat requirement, a team-up requirement, or a challenge (PK) requirement.

physical interaction (or strong interaction): It is interaction between a first three-dimensional model in a physical state and a second three-dimensional model in a physical state in the same virtual world. The first three-dimensional model and the second three-dimensional model are different three-dimensional models in the same virtual world.

In some embodiments, in the first virtual world, both the first virtual character and the first world element are in the physical state, and the physical interaction includes interaction between the first virtual character in the physical state and the first world element in the physical state.

In some embodiments, in the first virtual world, when the second virtual character is transformed from the ghost state to the physical state, the physical interaction includes interaction between the first virtual character in the physical state and the second virtual character in the physical state, and interaction between the second virtual character in the physical state and the first world element in the physical state.

For example, the physical interaction includes at least one of interactive behaviors such as battling, handshaking, collaboration, or the like.

Non-physical interaction (or weak interaction): It is interaction between a third three-dimensional model in a physical state and a fourth three-dimensional model in a ghost state in the same virtual world. The third three-dimensional model and the fourth three-dimensional model are different three-dimensional models in different virtual worlds, and are displayed in the physical state in respective virtual worlds.

In some embodiments, in the first virtual world, the first virtual character and the first world element are in the physical state, and the second virtual character is in the ghost state. The non-physical interaction includes interaction between the first virtual character in the physical state and the second virtual character in the ghost state, and interaction between the second virtual character in the ghost state and the first world element in the physical state.

In some embodiments, in the first virtual world, the first virtual character in the physical state performs non-physical interaction with the second virtual character in the ghost state, so that the second virtual character observes an action of the first virtual character in the second virtual world, or the first virtual character observes an action of the second virtual character in the first virtual world.

For example, the non-physical interaction includes at least one of interactive behaviors such as making a limb action, making an expression action, performing an agree operation on an interaction requirement, or the like, and the interaction requirement includes at least one of a chat requirement, a team-up requirement, or a challenge (PK) requirement.

In response to: This is configured for indicating a condition or status on which a performed operation depends, when the condition or status is met, one or more performed operations may be real-time or may have a set delay; and unless otherwise specified, an execution order of the plurality of performed operations is not limited.

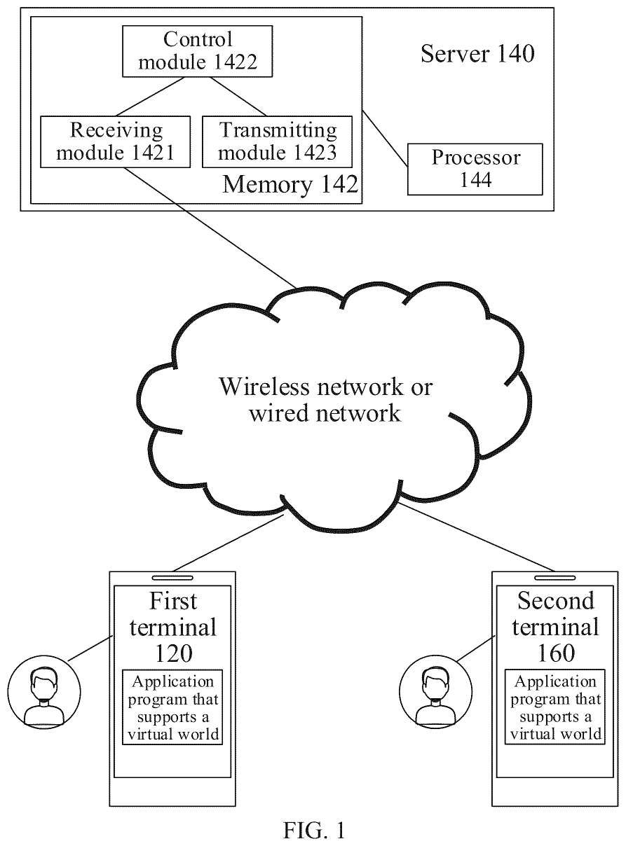

FIG. 1 is a structural block diagram of a computer system according to an exemplary embodiment of this application, and the computer system may be referred to as a system architecture implementing a virtual world-based character interaction method. The computer system includes: a first terminal 120, a server 140, and a second terminal 160.

An application program that supports a virtual world is installed and run on the first terminal 120. The application program may be any one of a role-playing game (RPG), a shooting game, a virtual reality (VR) application program, an augmented reality (AR) program, a three-dimensional map program, a VR game, an AR game, a first-person shooting (FPS) game, a third-person shooting (TPS) game, a multiplayer online battle arena (MOBA) game, or a simulation game (SLG).

The first terminal 120 is a terminal used by a first player. The first player uses the first terminal 120 to control a first virtual character located in a first virtual world. The control includes but is not limited to at least one of adjusting a body posture, crawling, walking, running, riding, jumping, driving, picking up, shooting, attacking, throwing, or constructing a virtual building. The first player may further observe an action and an expression of a second virtual character in the first virtual world through the first terminal 120, or initiate an interaction requirement to the second virtual character, or perform an agree operation on an interaction requirement initiated by the second virtual character. In some embodiments, the interaction requirement includes at least one of a chat requirement, a team-up requirement, or a challenge requirement. The first player may further enter a second virtual world from the first virtual world or enter a multiplayer virtual world from the first virtual world through the first terminal 120.

The first terminal 120 is connected to the server 140 through a wireless network or a wired network.

The server 140 may be a single-player server or may be a multiplayer server. The server 140 may be an independent physical server, or may be a server cluster including a plurality of physical servers or a distributed system, or may be a cloud server that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform. The server 140 includes at least one of one server, a plurality of servers, a cloud computing platform, or a virtualization center.

For example, the server 140 includes a processor 144 and a memory 142. The memory 142 further includes a receiving module 1421, a control module 1422, and a transmitting module 1423. The receiving module 1421 is configured to receive a request transmitted by a client, for example, an interaction request initiated to another virtual character or a request of entering a multiplayer virtual world. The control module 1422 is configured to control rendering of a virtual world picture. The transmitting module 1423 is configured to transmit a response to the client, for example, transmit interaction-related information of a virtual character to the client, or enter the multiplayer virtual world. The server 140 is configured to provide a backend service for the application programs of the first terminal 120 and the second terminal 160.

In some embodiments, the server 140 takes on primary computing work, and the first terminal 120 and the second terminal 160 take on secondary computing work; or the server 140 takes on secondary computing work, and the first terminal 120 and the second terminal 160 take on primary computing work; or collaborative computing is performed by using a distributed computing architecture among the server 140, the first terminal 120, and the second terminal 160.

An application program that supports a virtual world is installed and run on the second terminal 160. The application program may be any one of a role-playing game (RPG), a shooting game, a virtual reality (VR) application program, an augmented reality (AR) program, a three-dimensional map program, a VR game, an AR game, a first-person shooting (FPS) game, a third-person shooting (TPS) game, a multiplayer online battle arena (MOBA) game, or a simulation game (SLG).

The second terminal 160 is a terminal used by a second player. The second player uses the second terminal 160 to control a second virtual character located in a second virtual world. The control includes but is not limited to at least one of adjusting a body posture, crawling, walking, running, riding, jumping, driving, picking up, shooting, attacking, throwing, or constructing a virtual building. The second player may further observe an action and an expression of a first virtual character in the second virtual world through the second terminal 160, or initiate an interaction requirement to the first virtual character, or perform an agree operation on an interaction requirement initiated by the first virtual character. In some embodiments, the interaction requirement includes at least one of a chat requirement, a team-up requirement, or a challenge requirement. The second player may further enter the first virtual world from the second virtual world or enter the multiplayer virtual world from the second virtual world through the second terminal 160.

In some embodiments, the first virtual character controlled by the first player through the first terminal 120 and the second virtual character controlled by the second player through the second terminal 160 are located in different positions of the same virtual world. That is, the first player and the second player may be located in the same virtual world.

For example, both the first virtual character and the second virtual character are located in the first virtual world, in the first virtual world, the first virtual character is displayed in a physical state, and the second virtual character is displayed in a ghost state; or both the first virtual character and the second virtual character are located in the second virtual world, in the second virtual world, the first virtual character is displayed in a ghost state, and the second virtual character is displayed in a physical state; or both the first virtual character and the second virtual character are located in the multiplayer virtual world, and in the multiplayer virtual world, both the first virtual character and the second virtual character are displayed in a physical state.

In some embodiments, the application programs installed on the first terminal 120 and the second terminal 160 are the same, or the application programs installed on the two terminals are the same type of application programs of different control system platforms. Forms of the application programs installed on the first terminal 120 and the second terminal 160 are not limited in the embodiments of this application, including but not limited to an application (App), an applet, or the like installed on the first terminal 120 and the second terminal 160, and may alternatively be in the form of a web page. The first terminal 120 may generally refer to one of a plurality of terminals, and the second terminal 160 may generally refer to one of a plurality of terminals. In this embodiment, only the first terminal 120 and the second terminal 160 are used as an example for description. The first terminal 120 and the second terminal 160 have the same or different device types. The device type includes at least one of a smartphone, a tablet computer, a wearable device, a personal computer (PC), an e-book reader, a digital player, a laptop portable computer, or a desktop computer. An example in which the terminal includes a smartphone is used for description in the following embodiments.

A person skilled in the art may learn that there may be more or fewer terminals. For example, there may be only one terminal (that is, a player engages in a round with AI), or there may be eight terminals (1v1v1v1v1v1v1v1v1, where cyclical rounds and elimination are performed among eight players, to finally determine a winner), or there may be more terminals. A quantity and a device type of terminals are not limited in the embodiments of this application.

In some embodiments, in the virtual world-based character interaction method provided in the embodiments of this application, a scene includes a single-player scene and a multiplayer scene.

### Single-Player Scene

A plurality of players correspond to a plurality of virtual worlds, each player corresponds to an individual virtual world of the player, and the plurality of virtual worlds of the plurality of players are parallel worlds. In the individual virtual world of the player, the player manages data content of the individual virtual world, and a background stores all data related to the individual virtual world of the player. Virtual worlds of different players include the same world elements and world resources during initialization. At least one of world element changes, world resource changes, and game progresses in the virtual worlds of different players do not interfere with each other.

In addition to a target region, the second virtual character cannot enter the first virtual world in a physical state without authorization of the first virtual character, and the second virtual character enters the first virtual world in a ghost state by default. In a case of obtaining authorization of the first virtual character, the second virtual character may enter the first virtual world in a physical state and perform physical interaction such as chatting, teaming-up, or PK with the first virtual character.

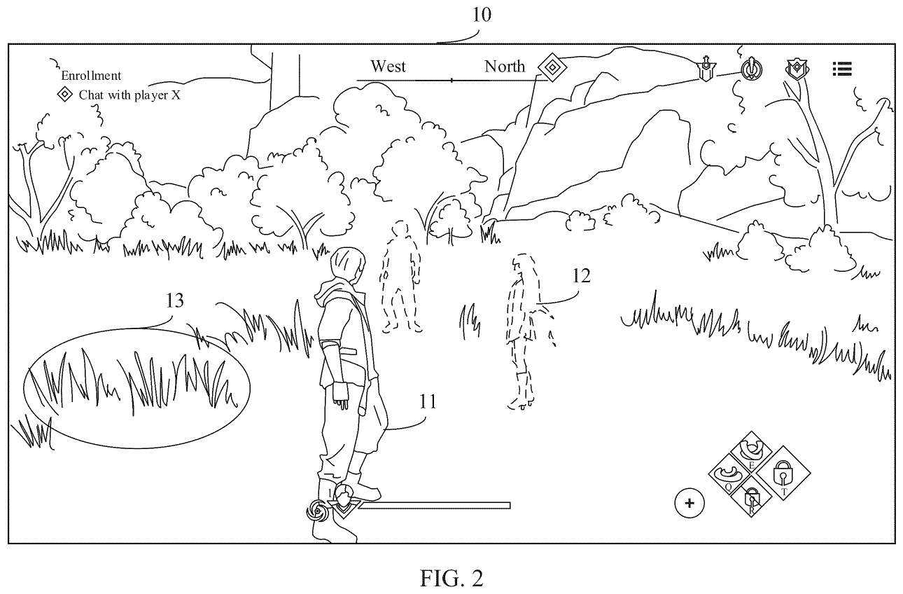

FIG. 2 is a schematic diagram of a virtual world-based character interaction method according to an exemplary embodiment of this application, and the schematic diagram may be a schematic diagram of a first virtual world of a first player.

For example, in FIG. 2, a first virtual world 10 is included, and a first virtual character 11, a second virtual character 12, and a world element 13 in the first virtual world 10 are included in the first virtual world 10. In some embodiments, the world element 13 is a virtual plant. In the first virtual world 10, the second virtual character 12 is displayed in a ghost state, and the first virtual character 11 and the world element 13 in the first virtual world 10 are displayed in a physical state. A first client displays the first virtual character 11 in the physical state in the first virtual world 10. In this embodiment, the physical state is indicated by using a solid line. The first client controls, in response to a control operation on the first virtual character 11, the first virtual character 11 to perform physical interaction with the world element 13 in the physical state in the first virtual world 10. The first client displays the second virtual character 12 in the ghost state in the first virtual world 10. In this embodiment, the ghost state is indicated by using a dashed line. The second virtual character 12 is a character controlled by a second client in a second virtual world, and the first virtual world and the second virtual world are parallel worlds. The first client controls the first virtual character 11 to perform non-physical interaction with the second virtual character 12. In the non-physical interaction, the second virtual character 12 does not need to perform physical interaction with the world element 13 in the first virtual world 10, that is, the second virtual character 12 does not perform physical interaction with the world element 13 during the non-physical interaction.

### Multiplayer Scene

Different players or different virtual characters may enter the multiplayer virtual world. In the multiplayer virtual world, the virtual characters are all displayed in a physical state. In the multiplayer virtual world, the player may perform physical interaction such as handshaking, battling, and collaboration, to shape a sense of the world.

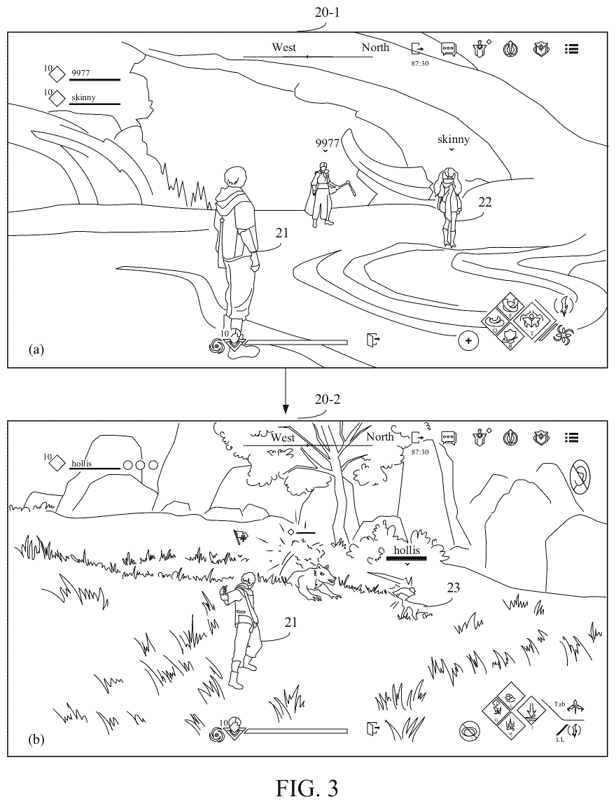

FIG. 3 is a schematic diagram of a virtual world-based character interaction method according to an exemplary embodiment of this application, and the schematic diagram may be a schematic diagram of a multiplayer virtual world of a first player.

For example, in FIG. 3(a), a multiplayer virtual world 20-1 is included, and a first virtual character 21 and a second virtual character 22 are included in the multiplayer virtual world 20-1, where both the first virtual character 21 and the second virtual character 22 are displayed in a physical state. The first virtual character 21 may perform physical interaction such as handshaking with the second virtual character 22. In FIG. 3(b), a multiplayer virtual world 20-2 is included, and a first virtual character 21 and a virtual monster 23 are included in the multiplayer virtual world 20-2, where both the first virtual character 21 and the virtual monster 23 are displayed in a physical state. The first virtual character 21 may perform physical interaction such as battling with the virtual monster 23.

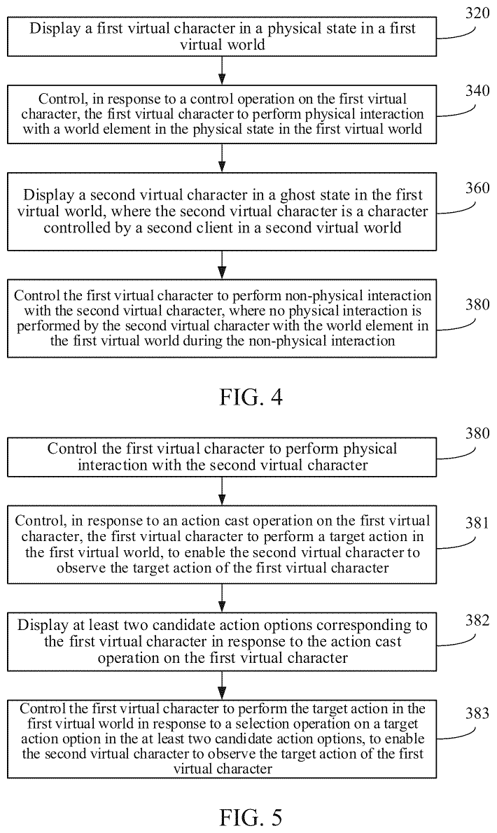

FIG. 4 is a flowchart of a virtual world-based character interaction method according to an exemplary embodiment of this application. An example in which the method is applied to the first terminal shown in FIG. 1 or the first client supporting a virtual world installed on the first terminal is used for description, and the method includes:

Operation 320. Display a first virtual character in a physical state in a first virtual world.

The first virtual world is an individual virtual world of a first player.

The first virtual character is a character played by the first player in the first virtual world. The first player controls the first virtual character through the first client.

In some embodiments, the first virtual character is a three-dimensional model, and the first virtual character includes one of a virtual person, a virtual animal, or a cartoon person.

In some embodiments, the control includes but is not limited to at least one of adjusting a body posture, crawling, walking, running, riding, jumping, driving, picking up, shooting, attacking, throwing, or constructing a virtual building.

The physical state refers to a display form with a collision size in a virtual world. When a world element in the physical state comes into contact with another world element in the physical state, at least one change of collision deformation and collision displacement is produced. In the first virtual world, the first virtual character is in the physical state.

For example, the first client displays the first virtual character in the physical state in the first virtual world.

Operation 340. Control, in response to a control operation on the first virtual character, the first virtual character to perform physical interaction with a world element in the physical state in the first virtual world.

The control operation is an operation in which the first player controls the first virtual character through the first client.

The world element includes various virtual elements appearing in the virtual world, which are configured for constituting the entire virtual world. The first virtual character controlled by the first player also belongs to one of world elements in the first virtual world.

In some embodiments, the world element includes plots, various virtual animals, various virtual plants, various virtual buildings, and the like. World elements constituting the first virtual world are in a physical state in the first virtual world.

The physical interaction refers to interaction between the first virtual character in the physical state and the world element in the physical state in the first virtual world.

In some embodiments, the physical interaction includes at least one of picking up by the first virtual character, moving a world element, battling, handshaking, or collaboration. In some embodiments, the physical interaction may further include at least one of farming, BOSS challenging, virtual item collection, or the like. For example, the world element is a virtual building, and the physical interaction may include moving the first virtual character to a position of the virtual building.

For example, the first client controls, in response to the control operation on the first virtual character, the first virtual character to perform physical interaction with the world element in the physical state in the first virtual world.

Operation 360. Display a second virtual character in a ghost state in the first virtual world, where the second virtual character is a character controlled by a second client in a second virtual world.

The second virtual world is an individual virtual world of a second player.

In some embodiments, the first virtual world and the second virtual world are parallel worlds. The parallel world is configured for representing that the first virtual world and the second virtual world exist at the same time, and include the same parameter such as space, time, or the like.

For example, during initialization, the first virtual world and the second virtual world include the same world elements and world resources, and at least one of world element changes, world resource changes, and game progresses in the first virtual world and the second virtual world do not interfere with each other.

The second virtual character is a character played by the second player in the second virtual world. The second player controls the second virtual character through the second client.

In some embodiments, the second virtual character is a three-dimensional model, and the second virtual character includes one of a virtual person, a virtual animal, or a cartoon person.

In some embodiments, the control includes but is not limited to at least one of adjusting a body posture, crawling, walking, running, riding, jumping, driving, picking up, shooting, attacking, throwing, or constructing a virtual building.

The ghost state refers to a display form without a collision size in a virtual world. When a world element in the ghost state comes into contact with another world element in the physical state, none change of collision deformation and collision displacement is produced. When a virtual character is in the ghost state, the virtual character cannot perform physical interaction with a world element in the virtual world.

In some embodiments, the second virtual character is in a ghost state in the first virtual world by default, and is in a physical state in the second virtual world; and the first virtual character is in a physical state in the first virtual world, and is in a ghost state in the second virtual world by default. The first virtual character in the physical state in the first virtual world can directly pass through the second virtual character without any obstruction.

For example, the first client displays the second virtual character in the ghost state in the first virtual world, where the second virtual character is a character controlled by the second client in the second virtual world, and the first virtual world and the second virtual world are parallel worlds.

In some embodiments, the second virtual character in the first virtual world may also be transformed from the ghost state to the physical state.

In some embodiments, in the first virtual world, when the second virtual character in the ghost state initiates an interaction requirement to the first virtual character in the physical state, and the first virtual character performs an agree operation on the interaction requirement, the second virtual character may be transformed from the ghost state to the physical state.

In some embodiments, the interaction requirement includes at least one of a chat requirement, a team-up requirement, or a challenge (PK) requirement. The interaction requirement may further include at least one of clothing interaction, partnership establishment interaction, town interaction, or clan interaction.

Operation 380. Control the first virtual character to perform non-physical interaction with the second virtual character, where no physical interaction is performed by the second virtual character with the world element in the first virtual world during the non-physical interaction.

The non-physical interaction refers to interaction between the world element in the physical state and the second virtual character in the ghost state in the first virtual world.

In some embodiments, in the first virtual world, the world element in the physical state includes plots, various virtual animals, various virtual plants, various virtual buildings, and the first virtual character.

For example, the first virtual character is controlled to perform non-physical interaction with the second virtual character, so that the first virtual character observes an action of the second virtual character in the first virtual world, or the second virtual character observes an action of the first virtual character in the second virtual world.

In some embodiments, the non-physical interaction includes at least one of interactive behaviors such as the first virtual character or the second virtual character making a limb action or an expression action, the first virtual character initiating an interaction requirement to the second virtual character, or the first virtual character performing an agree operation on an interaction requirement initiated by the second virtual character. The interaction requirement includes at least one of a chat requirement, a team-up requirement, or a challenge (PK) requirement.

In some embodiments, in the first virtual world, when the second virtual character is transformed from the ghost state to the physical state, the first virtual character in the physical state may further perform physical interaction with the second virtual character in the physical state. During the physical interaction, the second virtual character may perform physical interaction with the world element in the first virtual world.

For example, the physical interaction includes at least one of interactive behaviors such as battling, handshaking, collaboration, or the like.

Based on the above, by using the method provided in the embodiments of this application, compared with a single-player game, the player can interact with a real person, thereby weakening the loneliness of the single-player game. Compared with a multiplayer game, by constructing virtual worlds of different players and using a representation form of a ghost, the second virtual character does not interfere with a game process of the first virtual character, so that mutual interference and resource preemption between players of the multiplayer game are weakened, thereby increasing the immersed feeling of game experience and improving the game experience of the players.

In some embodiments, in the first virtual world, the first player may control, through the first client, the first virtual character in the physical state to perform non-physical interaction with the second virtual character in the ghost state. FIG. 5 is a flowchart of a virtual world-based character interaction method according to another exemplary embodiment of this application, where the foregoing Operation 380 may be implemented as the following Operation 381 in some embodiments:

Operation 381. Control, in response to an action cast operation on the first virtual character, the first virtual character to perform a target action in the first virtual world, to enable the second virtual character to observe the target action of the first virtual character. The target action includes at least one of a limb action and an expression action.

The action cast operation on the first virtual character is an operation of controlling the first virtual character to perform the target action in the first virtual world, and the action cast operation is triggered by the first player through the first client.

The target action is a specific action performed by the first virtual character in the first virtual world.

In some embodiments, the action cast operation includes at least one of a click/tap operation, a slide operation, a touch operation, or a multi-finger touch operation.

In some embodiments, the target action includes at least one of a limb action and an expression action.

In some embodiments, the limb action includes at least one of a gesture action and a body action. The gesture action includes actions such as hand waving, reaching out, first making, suspending a gesture, or the like. The body action includes actions such as standing, sitting down, turning around, leg lifting, jumping, or the like. The expression action includes actions such as smiling, crying, making a grimace, or the like.

In some embodiments, the limb action and the expression action may further be performed simultaneously. For example, during a hand waving action, a smiling face expression is also made.

For example, the first client controls, in response to the action cast operation on the first virtual character, the first virtual character to perform the target action in the first virtual world, to enable the second virtual character to observe the target action of the first virtual character.

When the first virtual character performs the target action in the first virtual world, the first virtual character may perform physical interaction with the world element in the first virtual world. For example, when the first virtual character performs a scrolling action, a grass in a scrolling region of the first virtual character in the first virtual world is deformed.

In some embodiments, the second client of the second player controls, in response to an action cast operation on the second virtual character, the second virtual character to perform a target action in the second virtual world, to enable the first virtual character to observe the target action of the second virtual character.

When the second virtual character performs the target action in the second virtual world, the second virtual character does not perform physical interaction with the world element in the first virtual world. For example, when the second virtual character performs a scrolling action, a grass in a scrolling region of the second virtual character in the first virtual world is not deformed.

In this embodiment, the first client controls, in response to the action cast operation on the first virtual character, the first virtual character to perform the target action in the first virtual world, so that the second virtual character can observe the target action of the first virtual character, thereby enriching interaction manners between players.

In some embodiments, since a plurality of target actions, limb actions, and expression actions may be included, based on this, a plurality of candidate action options may be displayed on the first client, for the first player to choose and determine a specific action to be performed. Still referring to FIG. 5, in some embodiment, Operation 381 may include Operation 382 and Operation 383:

Operation 382. Display at least two candidate action options corresponding to the first virtual character in response to the action cast operation on the first virtual character.

The candidate action option is an option of a candidate action to be performed by the first virtual character. The first virtual character has a plurality of candidate limb actions and candidate expression actions to be performed, that is, there are at least two candidate action options.

For example, the first client displays the at least two candidate action options corresponding to the first virtual character in response to the action cast operation on the first virtual character.

In some embodiments, the at least two candidate action options corresponding to the first virtual character are displayed in vicinity of the first virtual character. Different candidate action options are represented by using different candidate action elements, and the at least two candidate action options correspond to at least two candidate action elements.

In some embodiments, the candidate action element includes a hand waving element, a reaching out element, a first making element, a standing element, a sitting down element, a turning around element, a leg lifting element, or the like.

In some embodiments, the second client displays at least two candidate action options corresponding to the second virtual character in response to an action cast operation on the second virtual character.

Operation 383. Control the first virtual character to perform the target action in the first virtual world in response to a selection operation on a target action option in the at least two candidate action options, to enable the second virtual character to observe the target action of the first virtual character.

The target action option is a selected candidate action option of the at least two candidate action options.

The selection operation is an operation of selecting the target action option from the at least two candidate action options.

In some embodiments, the selection operation includes at least one of a click/tap operation, a slide operation, a touch operation, or a multi-finger touch operation.

For example, the target action performed by the first virtual character in the first virtual world may be observed by the second virtual character in the ghost state located in the first virtual world. The target action performed by the second virtual character in the second virtual world may be observed by the first virtual character in the ghost state located in the second virtual world.

For example, the first client controls the first virtual character to perform the target action in the first virtual world in response to the selection operation on the target action option in the at least two candidate action options, to enable the second virtual character to observe the target action of the first virtual character.

In some embodiments, the second client controls the second virtual character to perform the target action in the second virtual world in response to the selection operation on the target action option in the at least two candidate action options, to enable the first virtual character to observe the target action of the second virtual character.

In some embodiments, types of target actions, limb actions, and expression actions that can be performed by the first virtual character and the second virtual character are the same during initialization of the virtual worlds. Subsequently, based on at least one of an attribute, an equipment, a level, a virtual item held, or the like of each of the first virtual character and the second virtual character, the types of the target actions, the limb actions, and the expression actions may be increased or decreased.

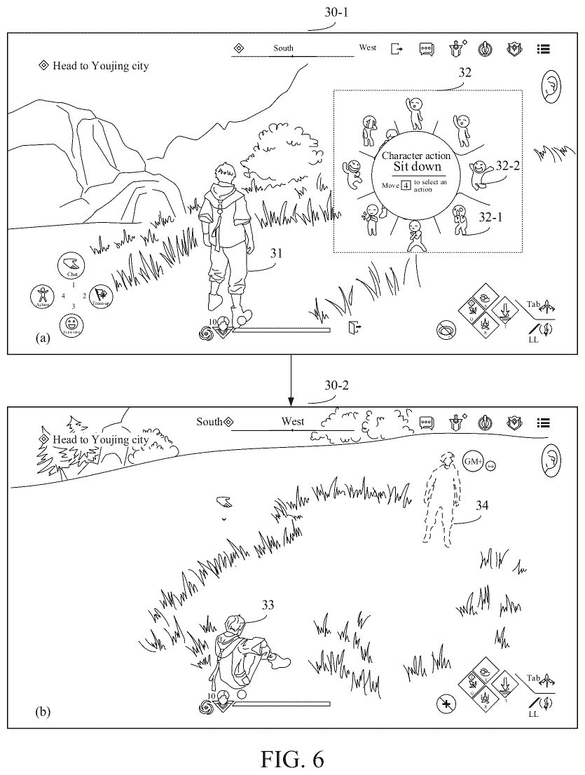

As an example, FIG. 6 is a schematic diagram of controlling a first virtual character to perform a target action in a first virtual world according to an exemplary embodiment of this application. The target action includes a limb action.

As shown in FIG. 6(a), a first virtual character 31 is included in a display interface 30-1 of the first virtual world. The first client displays, in response to an action cast operation on the first virtual character 31, at least two candidate action options corresponding to the first virtual character 31 in a display region 32 in vicinity of the first virtual character 31. For example, the at least two candidate action options include a candidate action option 32-1 and a candidate action option 32-2.

An example in which the target action is sitting down and the corresponding target action option is the candidate action option 32-2 is used. As shown in FIG. 6(b), a first virtual character 33 that sits down and a second virtual character 34 in a ghost state are included in a display interface 30-2 of the first virtual world. The first client controls, in response to a selection operation on the target action option 32-2 in the at least two candidate action options, the first virtual character 31 to perform the target action in the first virtual world. In this case, the first virtual character 31 in the display interface 30-1 is displayed as the first virtual character 33 that sits down in the display interface 30-2, so that the second virtual character 34 observes the target action of the first virtual character 33.

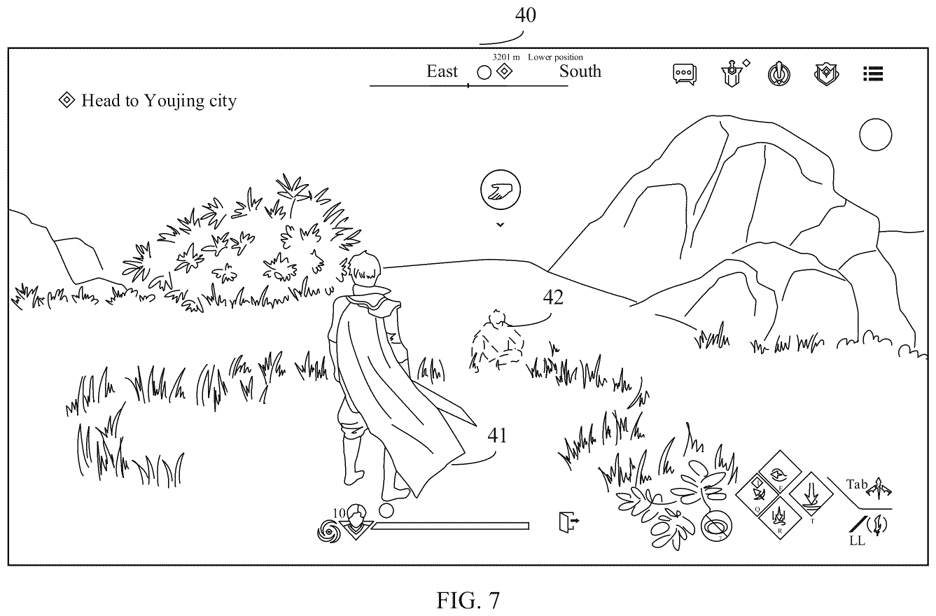

As an example, FIG. 7 is a schematic diagram of controlling a second virtual character to perform a target action in a second virtual world according to an exemplary embodiment of this application. The target action includes a limb action.

As shown in FIG. 7, a first virtual character 41 and a second virtual character 42 in a ghost state are included in a display interface 40 of the first virtual world. An example in which the target action is sitting down is used. The second client controls, in response to an action cast operation on the second virtual character 42, the second virtual character 42 to perform the target action in the second virtual world. In this case, in the display interface 40 of the first virtual world, the second virtual character is displayed as a second virtual character 42 that sits down and that is in a ghost state, so that the first virtual character 41 observes the target action of the second virtual character 42.

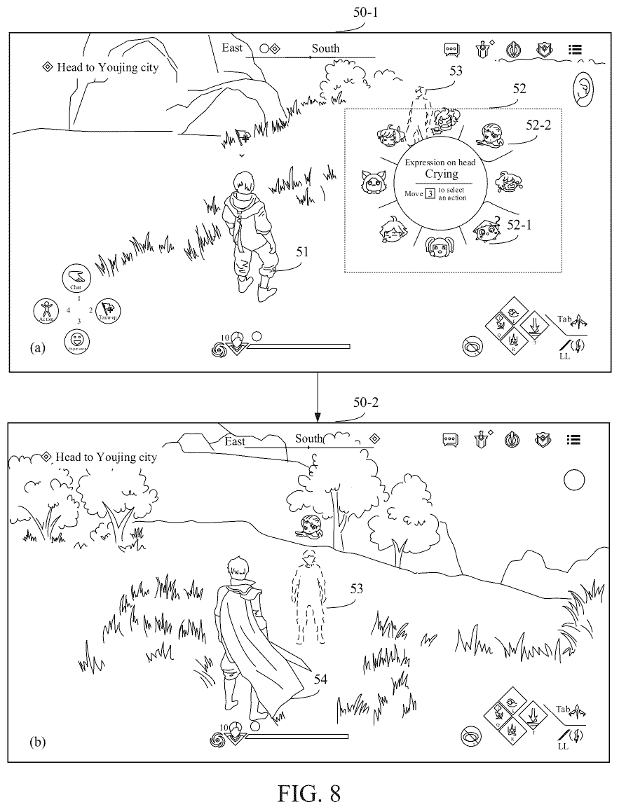

As an example, FIG. 8 is a schematic diagram of controlling a first virtual character to perform a target action in a first virtual world according to an exemplary embodiment of this application. The target action includes an expression action.

As shown in FIG. 8(a), a first virtual character 51 and a second virtual character 53 in a ghost state are included in a display interface 50-1 of the first virtual world. The first client displays, in response to an action cast operation on the first virtual character 51, at least two candidate action options corresponding to the first virtual character 51 in a display region 52 in vicinity of the first virtual character 51. For example, the at least two candidate action options include a candidate action option 52-1 and a candidate action option 52-2.

An example in which the target action is a crying expression and the corresponding target action option is the candidate action option 52-2 is used. As shown in FIG. 8(b), a first virtual character 54 with a crying expression and a second virtual character 53 in a ghost state are included in a display interface 50-2 of the first virtual world. The first client controls, in response to a selection operation on the target action option 52-2 in the at least two candidate action options, the first virtual character 51 to perform the target action in the first virtual world. In this case, the first virtual character 51 in the display interface 50-1 is displayed as the first virtual character 54 with a crying expression in the display interface 50-2, so that the second virtual character 53 observes the target action of the first virtual character 54.

In this embodiment, the first client provides, by displaying the at least two candidate action options, a plurality of candidate actions for the player to select, so that the gameplay of the game is enriched, the second virtual character can observe different actions of the first virtual character, and interaction manners of the player are enriched.

In some embodiments, based on any one of the foregoing embodiments, the first virtual character may interact with the second virtual character. In some embodiments, the interaction includes that the first virtual character initiates an interaction requirement to the second virtual character, or that the second virtual character initiates an interaction requirement to the first virtual character.

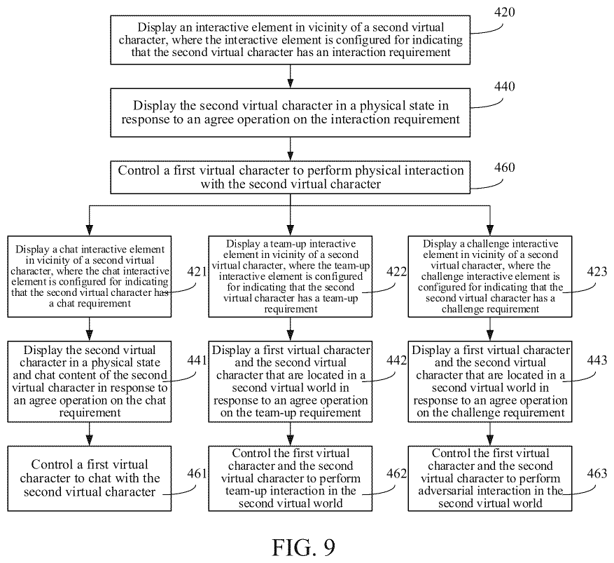

The following embodiments are described by using an example in which the second virtual character initiates an interaction requirement to the first virtual character and the process is displayed on the first client. FIG. 9 is a flowchart of a virtual world-based character interaction method according to another exemplary embodiment of this application. The method includes Operation 420, Operation 440, and Operation 460.

Operation 420. Display an interactive element in vicinity of a second virtual character, where the interactive element is configured for indicating that the second virtual character has an interaction requirement.

The interactive element is an element configured for indicating that the second virtual character has an interaction requirement.

The vicinity of the second virtual character represents at least one side around the second virtual character, for example, at least one of an upper side, a lower side, a left side, or a right side.

In some embodiments, the interaction includes at least one of chat, team up, or challenge (PK).

In some embodiments, different types of interaction correspond to different interactive elements, and the interactive element includes at least one of a chat interactive element, a team-up interactive element, or a challenge interactive element.

In some embodiments, the interactive element includes at least one of icons, symbols, or text with different shapes, sizes, or colors. A specific display form of the interactive element is not limited in the embodiments of this application.

For example, the first client displays the interactive element in the vicinity of the second virtual character, where the interactive element is configured for indicating that the second virtual character has an interaction requirement.

Operation 440. Display the second virtual character in a physical state in response to an agree operation on the interaction requirement.

The agree operation is an operation of accepting the interaction requirement.

In some embodiments, the agree operation includes at least one of a click/tap operation, a slide operation, a touch operation, or a multi-finger touch operation.

In some embodiments, the agree operation may be a trigger operation on the interactive element. For example, the agree operation is a click/tap operation on the interactive element.

For example, the first client displays the second virtual character in the physical state in response to the agree operation on the interaction requirement. Therefore, in the first virtual world, the second virtual character is transformed from the ghost state to the physical state. In this case, the first virtual character can perform physical interaction with the second virtual character.

Operation 460. Control a first virtual character to perform physical interaction with the second virtual character.

In some embodiments, the physical interaction includes at least one of interactive behaviors such as battling, handshaking, collaboration, or the like.

For example, the first client controls the first virtual character to perform physical interaction with the second virtual character.

During the physical interaction, the second virtual character may perform physical interaction with the world element in the first virtual world, that is, the second virtual character affects the world element in the first virtual world.

In this embodiment, the first client indicates, by displaying the interactive element in the vicinity of the second virtual character, that the second virtual character has an interaction requirement, which helps the player quickly determine another player having the interaction requirement. The first client displays the second virtual character in the physical state in response to the agree operation on the interaction requirement, which helps the player clearly see and interact with the another player having the interaction requirement, thereby enriching interaction manners between players.

In some embodiments, an example in which the second virtual character initiates an interaction requirement to the first virtual character and the interaction requirement is a chat requirement is used. Still referring to FIG. 9, in some embodiments, Operation 420 is implemented as Operation 421, Operation 440 is implemented as Operation 441, and Operation 460 is implemented as Operation 461.

Operation 421. Display a chat interactive element in vicinity of a second virtual character, where the chat interactive element is configured for indicating that the second virtual character has a chat requirement.

The chat interactive element is an element configured for indicating that the second virtual character has a chat interaction requirement.

In some embodiments, the chat interactive element includes at least one of a conversation bubble icon, a dialog box icon, or chat prompt text. For example, the chat prompt text may be “Player xx initiates a chat to you”.

For example, the first client displays the chat interactive element in the vicinity of the second virtual character, where the chat interactive element is configured for indicating that the second virtual character has a chat interaction requirement.

Operation 441. Display the second virtual character in a physical state and chat content of the second virtual character in response to an agree operation on the chat requirement.

The agree operation on the chat requirement is an operation of accepting the chat requirement.

For example, the first client displays the second virtual character in the physical state and the chat content of the second virtual character in response to the agree operation on the chat requirement.

In some embodiments, the agree operation may be a trigger operation on the chat interactive element. For example, the agree operation may be a click/tap operation on the conversation bubble icon.

In some embodiments, the first client displays a chat agreement element in vicinity of the first virtual character in response to the agree operation on the chat requirement, where the chat agreement element is configured for indicating that the first virtual character agrees with the chat requirement.

In some embodiments, the chat agreement element includes at least one of a conversation bubble icon, a dialog box icon, or chat agreement text. For example, the chat agreement text may be “A chat invitation has been accepted, and a chat interface may be opened for communication”.

Operation 461. Control a first virtual character to chat with the second virtual character.

For example, the first client controls the first virtual character to chat with the second virtual character.

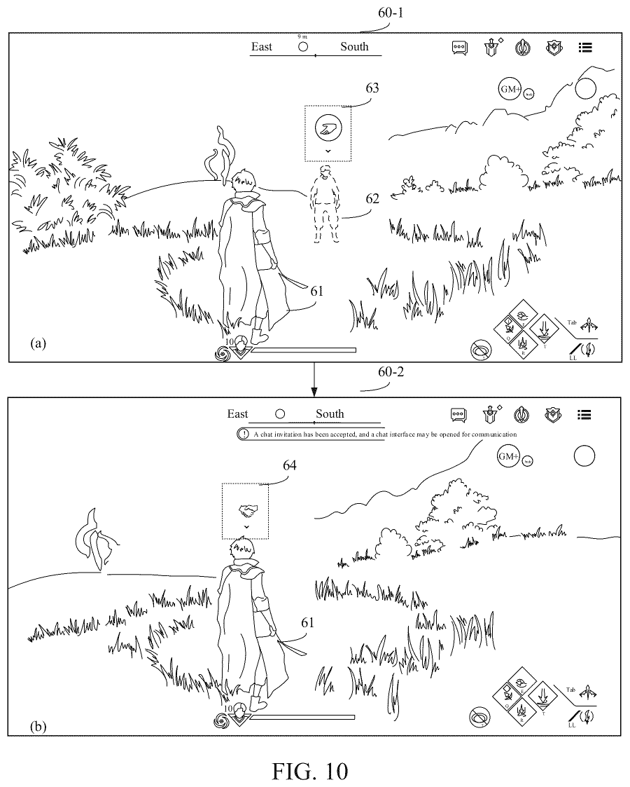

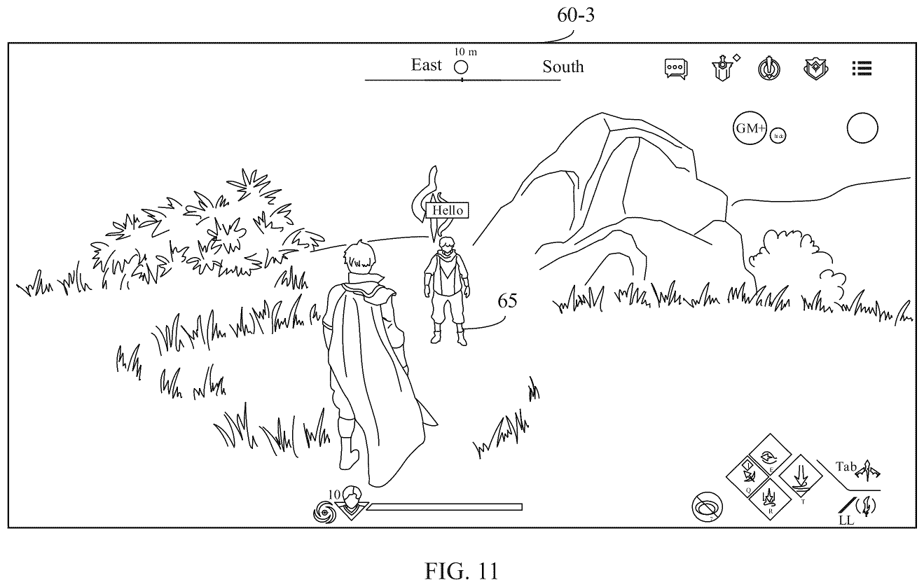

An example in which the second virtual character initiates a chat requirement to the first virtual character is used. FIG. 10 and FIG. 11 are schematic diagrams of controlling a first virtual character to chat with a second virtual character according to an exemplary embodiment of this application.

As shown in FIG. 10(a), a first virtual character 61 and a second virtual character 62 in a ghost state are included in a display interface 60-1 of the first virtual world. In the display interface 60-1 of the first virtual world, a chat interactive element 63 is displayed in vicinity (an upper side in this embodiment) of the second virtual character 62, where the chat interactive element is a hand icon, and the chat interactive element is configured for indicating that the second virtual character 62 has a chat requirement. As shown in FIG. 10(b), the first client displays, in response to an agree operation on the chat requirement, a chat agreement element 64 in vicinity (an upper side in this embodiment) of the first virtual character in a display interface 60-2 of the first virtual world, where the chat agreement element is a handshake icon, further display text “A chat invitation has been accepted, and a chat interface may be opened for communication”. As shown in FIG. 11, in a display interface 60-3 of the first virtual world, a second virtual character 65 in a physical state and chat content of the second virtual character 65 are displayed. For example, the chat content is “Hello”. The first client controls the first virtual character to chat with the second virtual character.

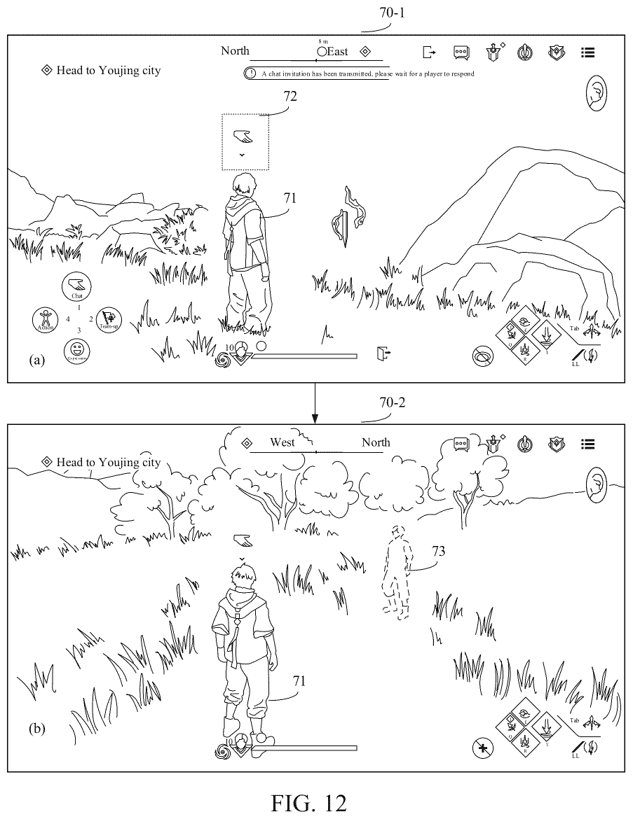

An example in which the first virtual character initiates a chat requirement to the second virtual character is used. FIG. 12 is a schematic diagram of controlling a first virtual character to chat with a second virtual character according to an exemplary embodiment of this application.

As shown in FIG. 12(a), a first virtual character 71 is included in a display interface 70-1 of the first virtual world. A chat interactive element 72 is displayed in vicinity (an upper side in this embodiment) of the first virtual character 71, where the chat interactive element is a hand icon, and the chat interactive element is configured for indicating that the first virtual character 71 has a chat requirement, and text “A chat invitation has been transmitted, please wait for a player to respond”. As shown in FIG. 12(b), the first virtual character 71 and a second virtual character 73 in a ghost state are included in a display interface 70-2 of the first virtual world. When the second client responds to an agree operation on the chat requirement, the second virtual character in a physical state and chat content of the first virtual character 71 are further displayed in the display interface 70-2, and the first client then controls the first virtual character 71 to chat with the second virtual character 73.

In this embodiment, the first client indicates, by displaying the chat interactive element in the vicinity of the second virtual character, that the second virtual character has a chat requirement, which helps the player quickly determine another player having the chat requirement. The first client displays the second virtual character in the physical state and the chat content of the second virtual character in response to the agree operation on the chat requirement, so that interaction manners between players are enriched, and interference to the player can be further avoided, thereby improving the game experience of the player.

In some embodiments, an example in which the second virtual character initiates an interaction requirement to the first virtual character and the interaction requirement is a team-up requirement is used. Still referring to FIG. 9, in some embodiments, Operation 420 is implemented as Operation 422, Operation 440 is implemented as Operation 442, and Operation 460 is implemented as Operation 462.

Operation 422. Display a team-up interactive element in vicinity of a second virtual character, where the team-up interactive element is configured for indicating that the second virtual character has a team-up requirement.

The team-up interactive element is an element indicating that the second virtual character has a team-up requirement.

In some embodiments, the team-up interactive element includes at least one of a team flag icon, a team item icon, or team-up prompt text. For example, the team-up prompt text may be “Player xx initiates a team-up request to you”.

For example, the first client displays the team-up interactive element in the vicinity of the second virtual character, where the team-up interactive element is configured for indicating that the second virtual character has a team-up requirement.

Operation 442. Display a first virtual character and the second virtual character that are located in a second virtual world in response to an agree operation on the team-up requirement.

The agree operation on the team-up requirement is an operation of accepting the team-up requirement.

For example, when the first virtual character accepts the team-up requirement of the second virtual character, the first virtual character enters the second virtual world in which the second virtual character is located and is displayed in a physical state.

For example, the first client displays the first virtual character and the second virtual character that are located in the second virtual world in response to the agree operation on the team-up requirement.

In some embodiments, the agree operation may be a trigger operation on the team-up interactive element. For example, the agree operation may be a click/tap operation on the team flag icon.

In some embodiments, the first client displays a team-up agreement element in vicinity of the first virtual character in response to the agree operation on the team-up requirement, where the team-up agreement element is configured for indicating that the first virtual character agrees with the team-up requirement.

In some embodiments, the team-up agreement element includes at least one of a team flag icon, a team item icon, or team-up agreement text. For example, the team-up agreement text may be “Entering a world of player xx, please wait”.

Operation 462. Control the first virtual character and the second virtual character to perform team-up interaction in the second virtual world.

For example, the first virtual character and the second virtual character are controlled to perform team-up interaction in the second virtual world. The team-up interaction is one type of physical interaction.

In some embodiments, when the first virtual character exits the team, the first virtual character may switch from the second virtual world back to the first virtual world. In the first virtual world, the first virtual character is displayed in a physical state, and the second virtual character is still displayed in the ghost state by default.

For example, in response to a team exit operation on the first virtual character, the first client displays the first virtual character and the second virtual character in the ghost state that are located in the first virtual world.

In some embodiments, the first client displays team exit prompt information in response to the team exit operation on the first virtual character. For example, the team exit prompt information may be text “Are you sure to leave the team”.

In some embodiments, when the first virtual character exits the team, the first virtual character may bring a virtual item, a virtual treasure box, a virtual spoil, or a virtual collection object obtained in the second virtual world back to the first virtual world.

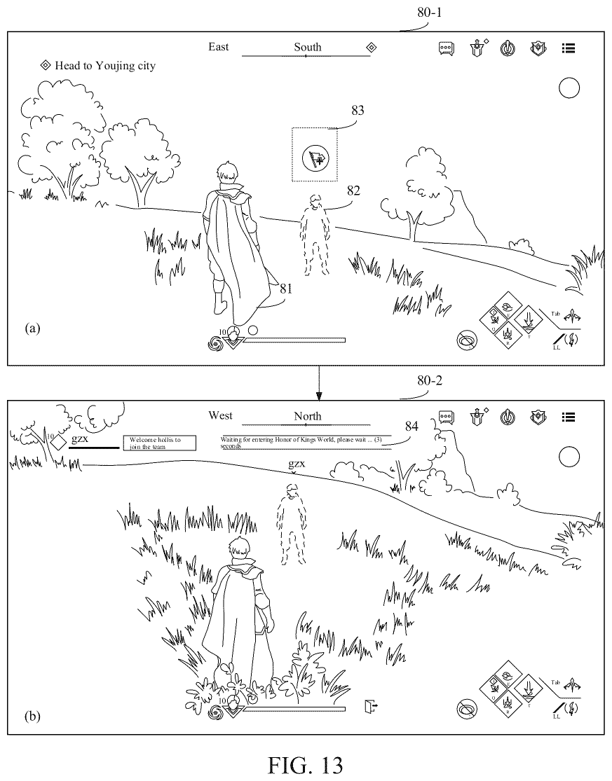

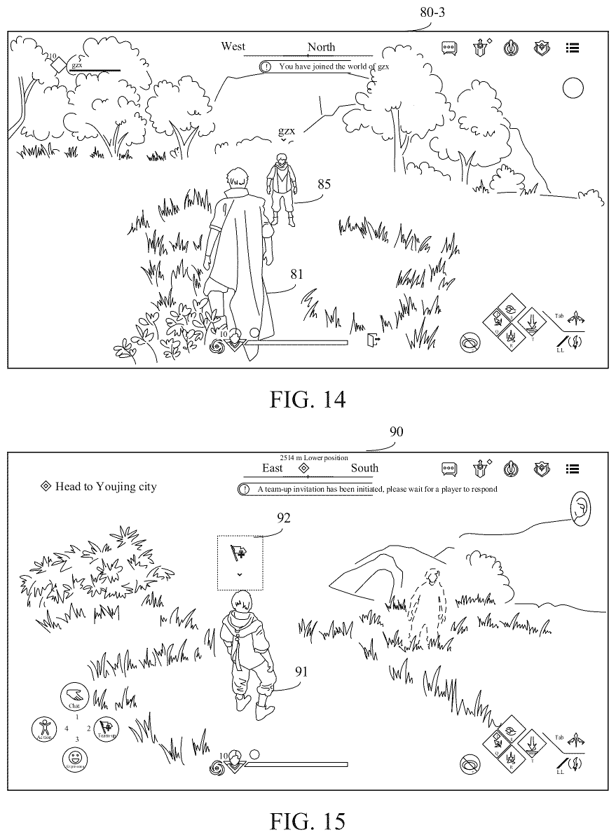

An example in which the second virtual character initiates a team-up requirement to the first virtual character is used. FIG. 13 and FIG. 14 show schematic diagrams of controlling a first virtual character to form a team with a second virtual character according to an exemplary embodiment of this application.

As shown in FIG. 13(a), a first virtual character 81 and a second virtual character 82 in a ghost state are included in a display interface 80-1 of the first virtual world. In the display interface 80-1 of the first virtual world, a team-up interactive element 83 is displayed in vicinity (an upper side in this embodiment) of the second virtual character 82, where the team-up interactive element is a team flag icon, and the team-up interactive element is configured for indicating that the second virtual character 82 has a team-up requirement. As shown in FIG. 13(b), the first client displays, in response to the agree operation on the team-up requirement, text “Entering a world of player xx, please wait” in a display region 84 in vicinity (an upper side in this embodiment) of the first virtual character in a display interface 80-2 of the first virtual world. Then, the first virtual character 81 enters the second virtual world of the second virtual character 82. As shown in FIG. 14, in a display interface 80-3 of the second virtual world, the first virtual character 81 and a second virtual character 85 in a physical state that are located in the second virtual world are displayed, and text “You have entered the world of player xx” is displayed, to prompt that the first virtual character 81 is located in the second virtual world in this case. The first client then controls the first virtual character 81 and the second virtual character 85 to perform team-up interaction in the second virtual world.

An example in which the first virtual character initiates a team-up requirement to the second virtual character is used. FIG. 15 is a schematic diagram of controlling a first virtual character to form a team with a second virtual character according to an exemplary embodiment of this application.

As shown in FIG. 15, in a display interface 90 of the first virtual world, a first virtual character 91 is included, and a team-up interactive element 92 is displayed in vicinity (an upper side in this embodiment) of the first virtual character 91, where the team-up interactive element is a team flag icon, and the team-up interactive element is configured for indicating that the first virtual character 91 has a team-up requirement. In addition, team-up prompt text “A team-up invitation has been initiated, please wait for a player to respond” is also displayed. After the second client responds to the agree operation on the team-up requirement, the second virtual character may enter the first virtual world of the first virtual character 91. The first client then controls the first virtual character 91 and the second virtual character to perform team-up interaction in the first virtual world.

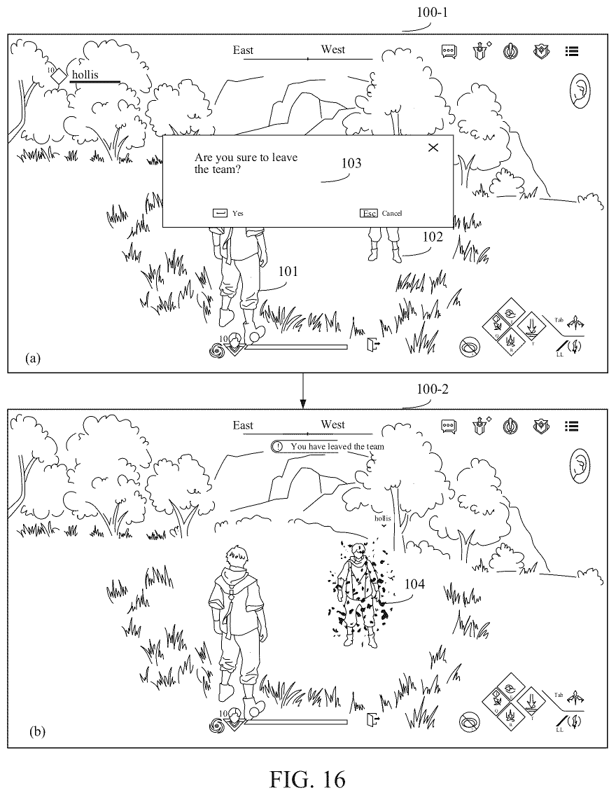

An example in which the first virtual character exits a team is used. FIG. 16 is a schematic diagram of controlling a first virtual character to exit a team according to an exemplary embodiment of this application.

The second virtual character initiates a team-up requirement to the first virtual character, and the first virtual character agrees to form a team with the second virtual character and enters the second virtual world. As shown in FIG. 16(a), a first virtual character 101 and a second virtual character 102 that are in a physical state are included in a display interface 100-1 of the second virtual world. The first client displays team prompt information 103 “Are you sure to leave the team” in response to a team exit operation on the first virtual character 101. Then, as shown in FIG. 16(b), the first client displays the first virtual character and a second virtual character 104 in a ghost state that are located in the first virtual world in a display interface 100-2 of the first virtual world, and displays text “You have leaved the team”. That is, the first virtual character switches from the second virtual world back to the first virtual world.

In this embodiment, the first client indicates, by displaying the team-up interactive element in the vicinity of the second virtual character, that the second virtual character has a team-up requirement, which helps the player quickly determine another player having the team-up requirement. The first client displays the first virtual character and the second virtual character that are located in the second virtual world in response to the agree operation on the team-up requirement, so that interaction manners between players are enriched, and the player can feel like being in the virtual world, thereby improving the game experience of the player.

In some embodiments, an example in which the second virtual character initiates an interaction requirement to the first virtual character and the interaction requirement is a challenge (PK) requirement is used. Still referring to FIG. 9, in some embodiments, Operation 420 is implemented as Operation 423, Operation 440 is implemented as Operation 443, and Operation 460 is implemented as Operation 463.

Operation 423. Display a challenge interactive element in vicinity of a second virtual character, where the challenge interactive element is configured for indicating that the second virtual character has a challenge requirement.

The challenge interactive element is an element indicating that the second virtual character has a challenge (PK) requirement.

In some embodiments, the challenge interactive element includes at least one of a challenge item icon or challenge prompt text. For example, the challenge prompt text may be “Player xx initiates a challenge to you”.

For example, the first client displays the challenge interactive element in the vicinity of the second virtual character, where the challenge interactive element is configured for indicating that the second virtual character has a challenge requirement.

Operation 443. Display a first virtual character and the second virtual character that are located in a second virtual world in response to an agree operation on the challenge requirement.

The agree operation on the challenge requirement is an operation of accepting the challenge requirement.

For example, when the first virtual character accepts the challenge requirement of the second virtual character, the first virtual character enters the second virtual world in which the second virtual character is located and is displayed in a physical state.

For example, the first client displays the first virtual character and the second virtual character that are located in the second virtual world in response to the agree operation on the challenge requirement.

In some embodiments, the agree operation is a trigger operation on the challenge interactive element. For example, the agree operation may be a click/tap operation on the challenge item icon.

In some embodiments, the first client displays a challenge agreement element in vicinity of the first virtual character in response to the agree operation on the challenge requirement, where the challenge agreement element is configured for indicating that the first virtual character agrees with the challenge requirement.

In some embodiments, the challenge agreement element includes at least one of a challenge item icon or challenge agreement text. For example, the challenge agreement text may be “Challenge has been accepted, and entering a world of player xx, please wait”.

Operation 463. Control the first virtual character and the second virtual character to perform adversarial interaction in the second virtual world.

For example, the first virtual character and the second virtual character are controlled to perform adversarial interaction in the second virtual world. The adversarial interaction is one type of physical interaction.

In some embodiments, when the first virtual character exits the challenge, the first virtual character may switch from the second virtual world back to the first virtual world. In the first virtual world, the first virtual character is displayed in a physical state, and the second virtual character is still displayed in the ghost state by default.

For example, in response to a challenge exit operation on the first virtual character, the first client displays the first virtual character and the second virtual character in the ghost state that are located in the first virtual world.

In some embodiments, the first client displays challenge exit prompt information in response to the challenge exit operation on the first virtual character. For example, the challenge exit prompt information may be text “Are you sure to exit the challenge”.

In some embodiments, when the first virtual character exits the challenge, the first virtual character may bring a virtual item, a virtual treasure box, a virtual spoil, or a virtual collection object obtained in the second virtual world back to the first virtual world.

In this embodiment, the first client indicates, by displaying the challenge interactive element in the vicinity of the second virtual character, that the second virtual character has a challenge requirement, which helps the player quickly determine another player having the challenge requirement. The first client displays the first virtual character and the second virtual character that are located in the second virtual world in response to the agree operation on the challenge requirement, so that adversarial interaction manners between players are enriched, and the player can feel like being in the virtual world, thereby improving the game experience of the player.

In some embodiments, the multiplayer virtual world is a common virtual world in which different players or different virtual characters can all exist together. In the multiplayer virtual world, all different virtual characters are displayed in a physical state.

In some embodiments, in the multiplayer virtual world, physical interaction may be performed between different virtual characters. For example, the physical interaction includes at least one of interactive behaviors such as battling, teaming up, collaboration, or the like.

For example, a target region is set in the individual virtual world of each player, and the virtual character may enter the multiplayer virtual world from the target region. In some embodiments, the multiplayer virtual world is also referred to as a multiplayer region.

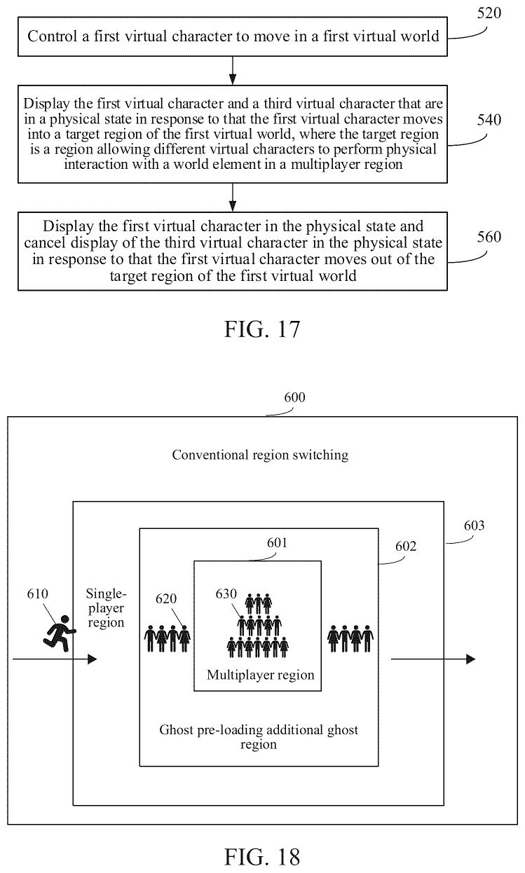

Based on this, based on any one of the foregoing embodiments, FIG. 17 is a flowchart of a virtual world-based character interaction method according to an exemplary embodiment of this application. In some embodiments, the method further includes the following operations:

Operation 520. Control a first virtual character to move in a first virtual world.

For example, the first client controls the first virtual character to move in the first virtual world.

Operation 540. Display the first virtual character and a third virtual character that are in a physical state in response to that the first virtual character moves into a target region of the first virtual world, where the target region is a region allowing different virtual characters to perform physical interaction with a world element in a multiplayer region.

In some embodiments, the target region is one or more specific regions in the first virtual world, and is a region that allows the first virtual character to switch from the first virtual world to the multiplayer virtual world, and perform physical interaction with the world element in the multiplayer virtual world.

The third virtual character is a virtual character other than the first virtual character in the multiplayer virtual world.

The multiplayer virtual world may also be referred to as a multiplayer region. A world element in the multiplayer region includes various virtual elements appearing in the multiplayer virtual world which are configured for constituting the entire multiplayer virtual world. The world element includes plots, lakes, the sky, various virtual animals, various virtual plants, various virtual buildings, and the like. The virtual character controlled by player, for example, the first virtual character or the third virtual character, also belongs to one of world elements.

For example, in the multiplayer region, all different virtual characters are displayed in a physical state. Based on this, physical interaction may be performed between different virtual characters and between different virtual characters and the world element in the multiplayer region.

For example, the first client displays the first virtual character and the third virtual character that are in the physical state in response to that the first virtual character moves into the target region of the first virtual world, where the target region is a region allowing different virtual characters to perform physical interaction with the world element in the multiplayer region.

In some embodiments, world elements included in target regions in different virtual worlds are consistent.

In some embodiments, region coordinates of target regions in different virtual worlds are consistent, or region positions of target regions in different virtual worlds may be customized by the player. That is, the region coordinates of the target regions in different virtual worlds are inconsistent.

In some embodiments, the first client displays prompt information before approaching the target region. The prompt information is configured for confirming whether to enter the target region. The first virtual character is controlled to move into the target region if a confirm operation is received. The first virtual character is forbidden from moving into the target region if a cancel operation is received.

Operation 560. Display the first virtual character in the physical state and cancel display of the third virtual character in the physical state in response to that the first virtual character moves out of the target region of the first virtual world.

For example, when the first virtual character moves out of the target region in the first virtual world, the first virtual character may return to the first virtual world. In the first virtual world, the first virtual character is displayed in the physical state, and the third virtual character in the physical state is not displayed.

In some embodiments, when the third virtual character in the multiplayer virtual world is the second virtual character in the first virtual world, when the first virtual character returns to the first virtual world, the third virtual character in a ghost state is displayed in the first virtual world.

For example, the first client displays the first virtual character in the physical state and cancels display of the third virtual character in the physical state in response to that the first virtual character moves out of the target region of the first virtual world.

In some embodiments, when the first virtual character moves out of the target region in the first virtual world, the first virtual character may bring a virtual item, a virtual treasure box, a virtual spoil, or a virtual collection object obtained in the multiplayer virtual world back to the first virtual world.

As an example, FIG. 18 is a schematic diagram of region switching according to an exemplary embodiment of this application. FIG. 18 shows a region 600 in the first virtual world. The region 600 includes a multiplayer region 601, a ghost pre-loading additional ghost region 602, and a single-player region 603.

For example, the multiplayer region 601 is a corresponding region in which a first virtual character 610 enters the multiplayer virtual world and can perform physical interaction with a third virtual character 630 in the multiplayer virtual world. The ghost pre-loading additional ghost region 602 is a transition region between the multiplayer region 601 and the single-player region 603, to avoid frequent switching between the individual virtual world and the multiplayer virtual world. In some embodiments, a second virtual character 620 in the ghost pre-loading additional ghost region 602 may be displayed in a ghost state, or may be displayed in a physical state. The single-player region 603 is a region corresponding to the first virtual world in which the first virtual character 610 is located.

When the first virtual character 610 moves into the single-player region 603, the first virtual character 610 is displayed in a physical state. When the first virtual character 610 moves into the ghost pre-loading additional ghost region 602, the first virtual character 610 may be displayed in a ghost state or in a physical state. When the first virtual character 610 moves into the multiplayer region 601, the first client switches from a scene of the first virtual world to a scene of the multiplayer virtual world, and the first virtual character 610 is displayed in a physical state.

In this embodiment, the first client controls the first virtual character to move in the first virtual world, and switches the first virtual character from the first virtual world to the multiplayer virtual world in response to that the first virtual character moves into the target region in the first virtual world. This switching manner is simple, and a player can implement seamless switching between different virtual worlds in the individual virtual world of the player, thereby enriching scene switching manners.

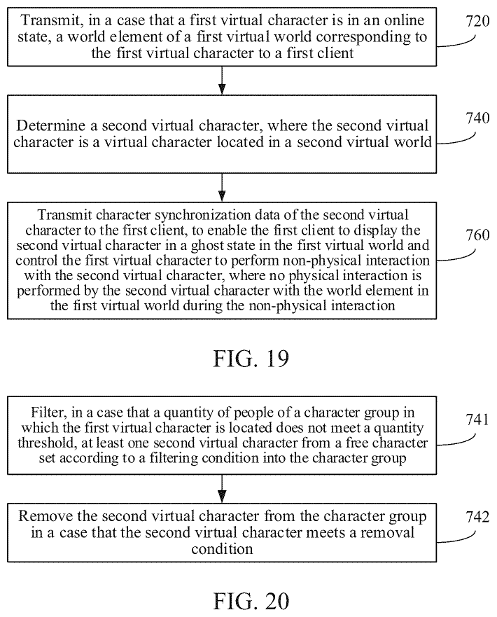

FIG. 19 is a flowchart of a virtual world-based character interaction method according to an exemplary embodiment of this application. An example in which the method is applied to the server 140 shown in FIG. 1 is used for description, and the method may include the following operations:

Operation 720. Transmit, when a first virtual character is in an online state, a world element of a first virtual world corresponding to the first virtual character to a first client.

The first virtual character is a character played by a first player in the first virtual world.

The first client is a client through which the first player controls the first virtual character.

For example, when the first virtual character is in the online state, the server transmits the world element of the first virtual world corresponding to the first virtual character to the first client, so that the first client loads and displays the first virtual world.

Operation 740. Determine a second virtual character, where the second virtual character is a virtual character located in a second virtual world.

In some other embodiments, the second virtual character is a virtual character belonging to the same character group as the first virtual character.

A character group is a small group including different virtual characters. The character group includes a plurality of virtual characters with a limited quantity, and the virtual characters included in the character group are adjustable.

The second virtual character is a character played by a second player in the second virtual world. The second player controls the second virtual character through a second client.

For example, the first virtual world and the second virtual world are parallel worlds.

For example, during initialization, the first virtual world and the second virtual world include the same world elements and world resources, and at least one of world element changes, world resource changes, and game progresses in the first virtual world and the second virtual world do not interfere with each other.

For example, the server determines the second virtual character belonging to the same character group as the first virtual character. In this way, the first virtual character in a physical state and the second virtual character in a ghost state are displayed in the first virtual world.

In some embodiments, the second virtual character is in a ghost state in the first virtual world by default, and is in a physical state in the second virtual world; and the first virtual character is in a physical state in the first virtual world, and is in a ghost state in the second virtual world by default. The first virtual character in the physical state in the first virtual world can directly pass through the second virtual character without any obstruction.

In some other embodiments, the second virtual character may be any virtual character that meets a display condition (which may not belong to the same character group as the first virtual character). For example, the display condition is: a distance between coordinates of the second virtual character in the second virtual world and coordinates of the first virtual character in the first virtual world is less than a distance threshold.

Operation 760. Transmit character synchronization data of the second virtual character to the first client, to enable the first client to display the second virtual character in a ghost state in the first virtual world and control the first virtual character to perform non-physical interaction with the second virtual character, where no physical interaction is performed by the second virtual character with the world element in the first virtual world during the non-physical interaction.

The character synchronization data is data configured for synchronizing virtual characters in different virtual worlds to the same virtual world.

For example, data of the second virtual character located in the second virtual world is synchronized to the first virtual world, to enable the first virtual character in the first virtual world to observe an action of the second virtual character. Alternatively, data of the first virtual character located in the first virtual world is synchronized to the second virtual world, to enable the second virtual character in the second virtual world to observe an action of the first virtual character.

In some embodiments, the character synchronization data includes at least one of character movement data, character battle data, character attribute data, character chat data, character action data, or character interaction requirement data.

The character movement data is configured for representing a movement situation of the second virtual character.

The character battle data is configured for representing a battle situation of the second virtual character.

In some embodiments, the character battle data includes at least one of historical battle data and real-time battle data.

The character attribute data is configured for representing a character attribute of the second virtual character.

In some embodiments, the character attribute includes at least one of a hit point attribute, a magic point attribute, an attack attribute, a defense attribute, or the like.

The character chat data is configured for representing chat content transmitted by the second virtual character to the first virtual character.

The character action data is configured for representing an action made by the second virtual character.

In some embodiments, the action of the second virtual character may be at least one of a limb action and an expression action.

The character interaction requirement data is configured for representing an interaction requirement initiated by the second virtual character to the first virtual character.

In some embodiments, the interaction requirement includes at least one of a chat requirement, a team-up requirement, or a challenge (PK) requirement.

In some embodiments, in the first virtual world, the first virtual character in the physical state may perform non-physical interaction with the second virtual character in the ghost state.

In some embodiments, the non-physical interaction includes at least one of interactive behaviors such as the first virtual character or the second virtual character making a limb action or an expression action, the first virtual character initiating an interaction requirement to the second virtual character, or the first virtual character performing an agree operation on an interaction requirement initiated by the second virtual character. The interaction requirement includes at least one of a chat requirement, a team-up requirement, or a challenge (PK) requirement.

For example, the server transmits the character synchronization data of the second virtual character to the first client, to enable the first client to display the second virtual character in the ghost state in the first virtual world and control the first virtual character to perform non-physical interaction with the second virtual character, where the second virtual character does not need to perform physical interaction with the world element in the first virtual world during the non-physical interaction.

Based on the above, by using the method provided in the embodiments of this application, the server transmits, when the first virtual character is in the online state, the world element of the first virtual world corresponding to the first virtual character to the first client; determines the second virtual character belonging to the same character group as the first virtual character, where the second virtual character is a virtual character located in the second virtual world, and the first virtual world and the second virtual world are parallel worlds; and transmits the character synchronization data of the second virtual character to the first client, to enable the first client to display the second virtual character in the ghost state in the first virtual world and control the first virtual character to perform non-physical interaction with the second virtual character, where the second virtual character does not need to perform physical interaction with the world element in the first virtual world during the non-physical interaction. By using the method provided in the embodiments of this application, interaction between players is loaded through the server, and compared with a single-player game, the player can interact with a real person, thereby weakening the loneliness of the single-player game. Compared with a multiplayer game, by constructing virtual worlds of different players and using a representation form of a ghost, the second virtual character does not interfere with a game process of the first virtual character, so that mutual interference and resource preemption between players of the multiplayer game are weakened, thereby increasing the immersed feeling of game experience and improving the game experience of the players.

In some embodiments, the server needs to determine the second virtual character belonging to the same character group as the first virtual character, to enable the first client to display the second virtual character in the ghost state in the first virtual world.

For example, FIG. 20 is a flowchart of a virtual world-based character interaction method according to an exemplary embodiment of this application. The foregoing Operation 740 may be implemented as Operation 741 below:

Operation 741. Filter, when a quantity of people of a character group in which the first virtual character is located does not meet a quantity threshold, at least one second virtual character from a free character set according to a filtering condition into the character group. The free character set includes virtual characters that do not join any character group, and virtual characters in the same character group are visible to each other or have permission of viewing other virtual characters in respective virtual worlds.

The quantity threshold is a reference value of the quantity of virtual characters included in the character group in which the first virtual character is located. In some embodiments, different character groups in which the first virtual character is located may correspond to different quantity thresholds.

The free character set is a set corresponding to virtual characters that do not join any character group.

The filtering condition is a condition corresponding to screening one or more virtual characters from the free character set to join the screened virtual characters to the character group in which the first virtual character is located.

After the screened virtual character joins the character group in which the first virtual character is located, the screened virtual character is also referred to as a second virtual character.

For example, when the quantity of people in the character group in which the first virtual character is located does not meet the quantity threshold (that is, less than the quantity threshold), at least one second virtual character is filtered from the free character set according to the filtering condition into the character group.

In some embodiments, when the quantity of people in the character group in which the first virtual character is located is greater than or equal to the quantity threshold, there is no need to filter the second virtual character from the free character set into the character group.

In some embodiments, the virtual characters in the same character group are visible to each other or have permission of viewing other virtual characters in respective virtual worlds.

For example, the filtering condition is related to at least one of the following factors:
whether the first virtual character and the second virtual character have a team-up relationship;
a character attribute or a character attribute value of the first virtual character;
a character attribute or a character attribute value of the second virtual character;
a position of the first virtual character;
a position of the second virtual character;
a field of view of the first virtual character; or
a field of view of the second virtual character.

That the first virtual character and the second virtual character have a team-up relationship means that the first virtual character and the second virtual character have formed a team before a current moment.

In some embodiments, when the first virtual character and the second virtual character have a team-up relationship, the second virtual character may be filtered preferentially.

The character attribute includes at least one of a hit point attribute, a magic point attribute, an attack attribute, a defense attribute, or the like. The character attribute value includes at least one of a hit point attribute value, a magic point attribute value, an attack attribute value, a defense attribute value, or the like.

In some embodiments, when the character attribute or the character attribute value of the second virtual character and the character attribute or the character attribute value of the first virtual character are close or can generate a positive gain effect, the second virtual character can be filtered preferentially.

The position of the first virtual character is a real-time position at which the first virtual character is located at the current moment. The position of the second virtual character is a real-time position at which the second virtual character is located at the current moment.

The field of view of the first virtual character is configured for representing a maximum range observable by the first virtual character. The field of view of the second virtual character is configured for representing a maximum range observable by the second virtual character.

In some embodiments, when positions of the first virtual character and the second virtual character are close or in the same position region, the second virtual character may be filtered preferentially.

In some embodiments, when the second virtual character is within the field of view of the first virtual character, the second virtual character may be filtered preferentially.

In a possible implementation, the second virtual character may be all virtual characters in the character group, or may be some virtual characters in the character group that meets a display condition. For example, the display condition is: within a target range in vicinity of the first virtual character.

In this embodiment, the server filters, when the quantity of people in the character group in which the first virtual character is located does not meet the quantity threshold, at least one second virtual character from the free character set according to the filtering condition into the character group, so that the adjustability of the virtual characters in the character group is implemented. Therefore, different players can be seen in the first virtual world, making the virtual world more real, and further, interaction can be performed with different players, so that a quantity of people that can be interacted with by the player is increased, thereby enriching interaction manners.

In some embodiments, because the virtual characters in the character group are adjustable, the server may add the second virtual character to the character group or remove the second virtual character from the character group. This removal process is also referred to as splitting. Based on this, referring to FIG. 20, the method further includes the following Operation 742:

Operation 742. Remove the second virtual character from the character group when the second virtual character meets a removal condition. The removal condition includes at least one of: the second virtual character gets offline, a distance between the second virtual character and the first virtual character is greater than a threshold, or the second virtual character forms a team with another virtual character.

Splitting the second virtual character from the character group means removing the second virtual character from the character group.

The removal condition is a condition that needs to be met for removing the second virtual character from the character group.

In some embodiments, the distance threshold may be set according to an actual technical requirement, which is not limited in this embodiment.

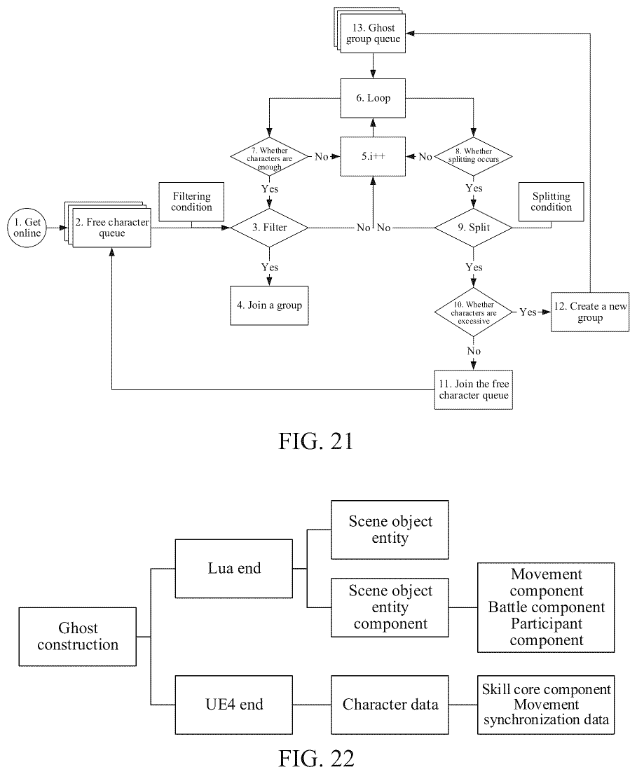

For example, FIG. 21 is a schematic diagram of determining a second virtual character belonging to the same character group as a first virtual character according to an exemplary embodiment of this application. A whole logic process of the schematic diagram is as follows:
1. A virtual character gets online.
2. Add the virtual character to a free character queue (free character set).
3. Determine whether the virtual character in the free character queue meets a filtering condition; enter 4 if the virtual character in the free character queue meets the filtering condition; and enter 5 if the virtual character in the free character queue does not meet the filtering condition.
4. Add the virtual character meeting the filtering condition to a character group.
5. Record a quantity i of executions, and enter 6.
6. Logical loop, enter 7 and 8 respectively.
7. Determine whether the character group lacks virtual characters, enter 3 if the character group lacks virtual characters, and enter 5 if the character group does not lack virtual characters.
8. Determine whether the character group is split, enter 9 if the character group is split, and enter 5 if the character group is not split.
9. Determine whether virtual characters in the character group meet a splitting condition; enter 10 if the virtual character in the character group meets the splitting condition; and enter 5 if the virtual characters in the character group does not meet the splitting condition.
10. Determine whether there are excessive virtual characters in the character group (where a quantity of people exceeds a quantity threshold); enter 12 if there are excessive virtual characters in the character group; otherwise, enter 11.
11. Add the virtual characters to the free character queue.
12. Create a new character group and enter 13.
13. Use the character group as a ghost character group queue and enter 6.

The foregoing ghost character group queue is an optional redundant design, and may be configured for maintaining a queue.

In this embodiment, the server splits the second virtual character from the character group when the second virtual character meets the splitting condition, so that the adjustability of the virtual characters in the character group is achieved. In this way, different players can be seen in the first virtual world, making the virtual world more real, and further, interaction can be performed with different players, so that a quantity of people that can be interacted with by the player is increased, thereby enriching interaction manners.

In some embodiments, the server transmits the character synchronization data of the second virtual character to the first client, to enable the first client to display the second virtual character in the ghost state in the first virtual world and control the first virtual character to perform non-physical interaction with the second virtual character.

In some embodiments, after the first client receives the character synchronization data, the second virtual character in the ghost state is displayed in the first virtual world, that is, ghost synchronization is performed in the first client. In this embodiment, the ghost synchronization includes processes of ghost construction, ghost data synchronization, and ghost movement battle synchronization.

### Ghost Construction

FIG. 22 is a schematic diagram of ghost construction according to an exemplary embodiment of this application. The ghost construction includes the following two parts:

1. A scene item entity and a scene item entity component at a Lua end.

The scene item entity component includes at least one of a movement component, a battle component, and a participant component.

Lua is a scripting language. The scene item (Entity) has a plurality of component members. The component is a member that stores a related attribute of the scene object (Entity).

2. Character data (Character) invocation at a UE4 end.

The character data includes at least one of a skill core component (USmoothSync) for movement synchronization and battle-related movement synchronization data (SkillCoreComponent).

UE4 is a type of game development software. The character data (Character) is a special type of scene object (Entity), and may be a specific entity such as a special player or a non-player character (NPC).

### Ghost Data Synchronization

In this embodiment, data members and initialization synchronization are defined as follows:
1. Component: It is configured for mounting data initialization (init), and the component is constructed according to a CompDef_NetMode type and a CSNetMode type.
2. ActorData: It is original data of a player, including information such as guid, character_id, style_id, and the like.
3. ViewActor: It is an observed Actor. The server determines, based on the CSNetMode, whether to transmit tcp or receive tcp synchronization, invokes SmoothSync in the UE4, and needs to invoke an AfterBindViewActor.
4. Viewcontroller: It is a controller of an observed object.
5. CSNetMode: It is a network mode, which is divided into none, autonomous, and ghost.
6. Guid: It is a unique ID for distinguishing and has a get/set method.

### Ghost Movement Battle Synchronization

In this embodiment, the ghost movement battle synchronization part is content mainly implemented by movement synchronization, and overall structures of the same type of AbilitySyncComponent (battle synchronization) and ParticipantSyncComponent (participant synchronization) are the same as that of the part.

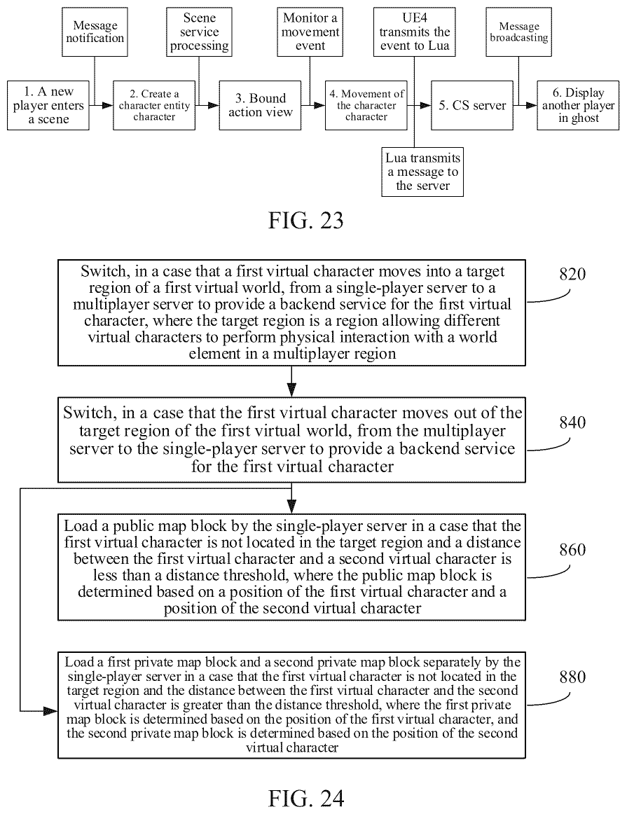

FIG. 23 is a schematic diagram of ghost movement battle synchronization according to an exemplary embodiment of this application. The following operations are included:
1. A new player enters a scene and triggers a message notification (AddMapActorNtf).
2. Invoke a character entity creation character (SpawEntityCharacterizer) in scene service processing (SceneEntityService).
3. Invoke a bound action view (ViewActor) to monitor a movement event.
4. When a virtual character moves, a movement event is transmitted in the USmoothSync in the UE4, and the Lua end monitors a corresponding event.
5. The Lua end transmits movement synchronization data to a CS server. In this embodiment, the movement synchronization data includes: at least one of a guid and movement byte stream data sync_data of a moving object.
6. After receiving the data, the CS server broadcasts the data to all people (except a message transmitter) connected to the CS server in a control system (ControlSystem), and completes a movement synchronization process, so that other players are displayed in a ghost state.

In this embodiment, the server transmits the character synchronization data of the second virtual character to the first client, so that time synchronization, data synchronization, action synchronization, and the like between the first virtual world and the second virtual world are implemented, so that the first virtual world and the second virtual world can become parallel worlds. In addition, real-time actions of the second virtual character located in the second virtual world can be seen in the first virtual world, making the virtual world more real, thereby improving the game experience of the player.

In some embodiments, the second virtual character may initiate an interaction requirement to the first virtual character. When the interaction requirement is a team-up requirement or a challenge requirement, the method may further include: when the first virtual character agrees with the team-up requirement or the challenge requirement of the second virtual character, the server migrates the first virtual character from the first virtual world to the second virtual world. Therefore, the first virtual character and the second virtual character that are in the physical state are displayed in the second virtual world.

In this embodiment, the server can implement seamless switching and seamless migration between different virtual worlds by migrating the first virtual character from the first virtual world to the second virtual world.

In some embodiments, different virtual characters can all enter the multiplayer virtual world from respective individual virtual worlds. In the multiplayer virtual world, all the different virtual characters are displayed in the physical state.

In some embodiments, in the multiplayer virtual world, physical interaction may be performed between different virtual characters. For example, the physical interaction includes at least one of interactive behaviors such as battling, handshaking, collaboration, or the like.

Based on this, FIG. 24 is a flowchart of a virtual world-based character interaction method according to an exemplary embodiment of this application. The method may include the following Operations:

Operation 820. Switch, when a first virtual character moves into a target region of a first virtual world, from a single-player server to a multiplayer server to provide a backend service for the first virtual character, where the target region is a region allowing different virtual characters to perform physical interaction with a world element in a multiplayer region.

The target region is one or more specific regions in the first virtual world, and is a region that allows the first virtual character to switch from the first virtual world to a multiplayer virtual world and perform physical interaction with a world element in the multiplayer virtual world. In some embodiments, the multiplayer virtual world is also referred to as a multiplayer region.

The single-player server is a server that provides a backend service for the first virtual character in a single-player scene (for example, a scene of the first virtual world).

The multiplayer server is a server that provides a backend service for the first virtual character in a multiplayer scene (for example, a scene of a multiplayer virtual world).

For example, when the first virtual character moves into the target region in the first virtual world, switching is performed from the single-player server to the multiplayer server to provide a backend service for the first virtual character.

Operation 840. Switch, when the first virtual character moves out of the target region of the first virtual world, from the multiplayer server to the single-player server to provide a backend service for the first virtual character.

For example, when the first virtual character moves out of the target region in the first virtual world, the first virtual character may return to the first virtual world.

For example, when the first virtual character moves out of the target region in the first virtual world, switching is performed from the multiplayer server to the single-player server to provide a backend service for the first virtual character.

In this embodiment, according to a specific game situation of the first virtual character, the server that provides the backend service may switch from the single-player server to the multiplayer server to provide a backend service for the first virtual character, which can improve the stability of the backend service.

In some embodiments, in the multiplayer virtual world, different virtual characters may form a team to complete physical interaction together. In this case, since different virtual characters need to see each other, the server needs to load more data content. Based on this, to avoid overloading of the server, still referring to FIG. 24. Based on Operation 820 and Operation 840, the method may further include the following Operation 860 or Operation 880:

Operation 860. Load a public map block by the single-player server when the first virtual character is not located in the target region and a distance between the first virtual character and a second virtual character is less than a distance threshold, where the public map block is determined based on a position of the first virtual character and a position of the second virtual character.

The position of the first virtual character is a real-time position of the first virtual character at a current moment.

The position of the second virtual character is a real-time position of the second virtual character at the current moment.

That the first virtual character is not located in the target region indicates that the first virtual character is in an individual virtual world (the first virtual world).

The distance threshold is a set maximum value of a distance between different virtual characters.

The public map block is a map block determined based on the position of the first virtual character and the position of the second virtual character. The first virtual character and the second virtual character located in the public map block can see each other.

For example, when the first virtual character is not located in the target region and the distance between the first virtual character and the second virtual character is less than the distance threshold, the single-player server loads the public map block determined based on the position of the first virtual character and the position of the second virtual character.

Operation 880. Load a first private map block and a second private map block separately by the single-player server when the first virtual character is not located in the target region and the distance between the first virtual character and the second virtual character is greater than the distance threshold, where the first private map block is determined based on the position of the first virtual character, and the second private map block is determined based on the position of the second virtual character.

The first private map block is a private map block in which the first virtual character is located that is determined based on the position of the first virtual character.

The second private map block is a private map block in which the second virtual character is located that is determined based on the position of the second virtual character.

In some embodiments, sizes of the first private map block and the second private map block may be the same or different.

In some embodiments, the first virtual character located in the first private map block and the second virtual character located in the second private map block cannot see each other.

For example, when the first virtual character is not located in the target region and the distance between the first virtual character and the second virtual character is greater than the distance threshold, the single-player server separately loads the first private map block determined based on the position of the first virtual character and the second private map block determined based on the position of the second virtual character.

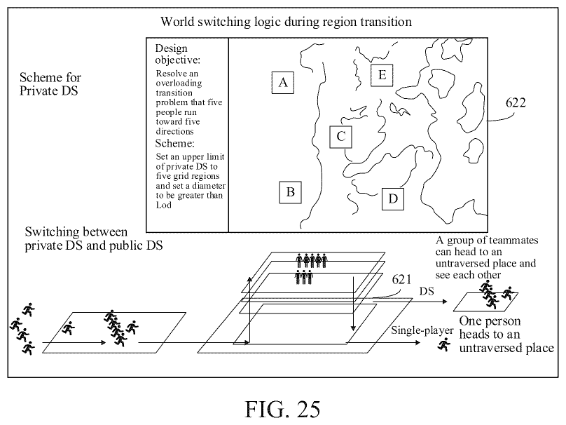

As an example, FIG. 25 is a schematic diagram of region switching according to an exemplary embodiment of this application. In the schematic diagram, a solution in which a single-player server provides a backend service and a solution in which switching is performed between a single-player server and a multiplayer server to provide a backend service are provided. FIG. 25 includes five virtual characters, which are respectively virtual characters A, B, C, D, and E.

An example in which the first virtual character is the virtual character A is used. When the virtual character A moves into a target region 621 in the first virtual world, switching is performed from the single-player server to the multiplayer server to provide a backend service for the first virtual character. When the virtual character A moves out of the target region 621 in the first virtual world, switching is performed from the multiplayer server to the single-player server to provide a backend service for the first virtual character.

For example, when none of the virtual characters A, B, C, D, and E in FIG. 25 is located in the target region 621 and distances between the virtual characters A, B, C, D, and E are all less than the distance threshold, the single-player server loads a public map block determined based on positions of the virtual characters A, B, C, D, and E. When none of the virtual characters A, B, C, D, and E is located in the target region 621 and a distance between any two virtual characters is greater than the distance threshold, an example in which the distances between the virtual characters A, B, C, D, and E in FIG. 25 are all greater than the distance threshold is used, the single-player server loads private map blocks determined based on the positions of the virtual characters A, B, C, D, and E separately and displays the private map blocks in a display region 622.

In this embodiment, the server selectively loads a corresponding map block based on the distance between the first virtual character and the second virtual character, which can avoid overloading of the server.

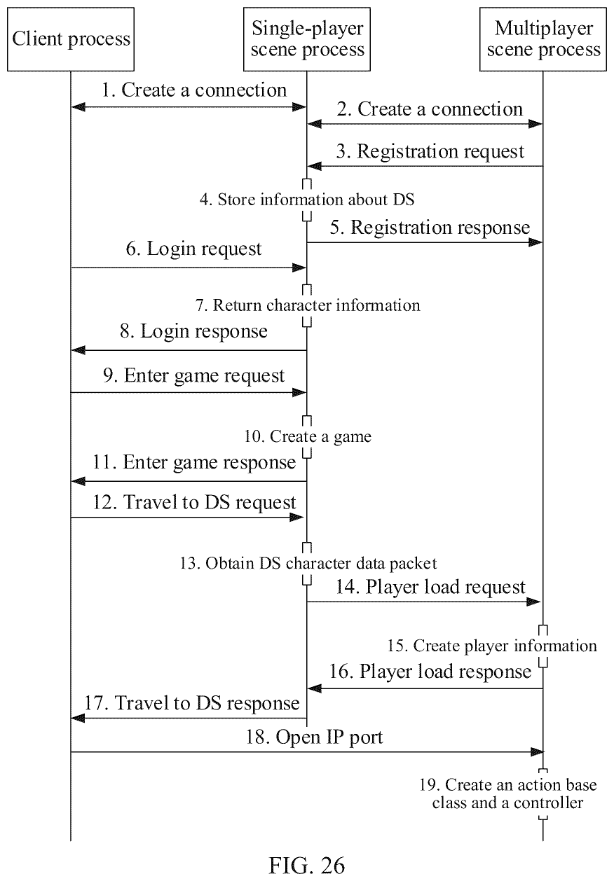

In some embodiments, FIG. 26 is a schematic diagram of interaction between an individual virtual world and a multiplayer virtual world according to an exemplary embodiment of this application.

In FIG. 26, a client process (Client), a single-player scene process (CS), and a multiplayer scene process (DS) are involved, and interaction operations among the three processes are as follows:
1. The Client establishes a connection with the CS.
2. The CS establishes a connection with the DS.
3. The DS transmits a registration request (DSRegisterReq) to the CS.
4. The CS stores information about the DS.
5. The CS transmits a registration response (SD RegisterRsp) to the DS.
6. The Client transmits a login request (CSLoginReq) to the CS.
7. The CS returns character information.
8. The CS transmits a login response (CSLoginRsp) to the Client.
9. The Client transmits an enter game request (CSEnterGameReq) to the CS.
10. The CS creates a game.
11. The CS transmits an enter game response (CSEnterGameRsp) to the Client.
12. The Client transmits a travel to DS request (CSTravelToDSReq) to the CS.
13. The CS obtains a character data packet (Package Role Data).
14. The CS transmits a player loading request (SDPlayerReq) to the DS.
15. The DS creates player information.
16. The DS transmits a player loading response (DSPlayerRsp) to the CS.
17. The CS transmits a travel to DS request (SCTravelToDSRsp) to the DS.
18. An open ip port (open ip: port).
19. The DS creates an action base class and a controller (Creat Pawn and Controller).

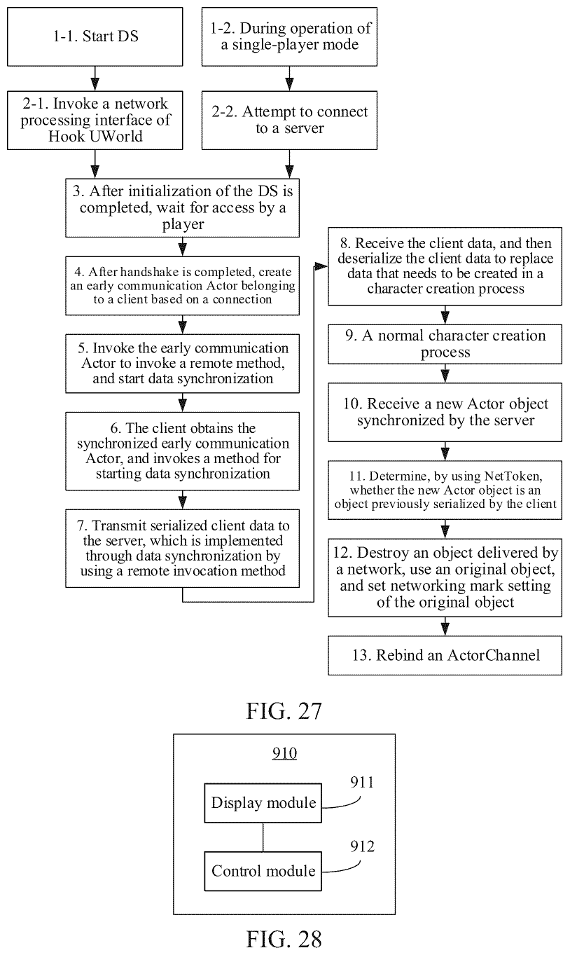

In some embodiments, FIG. 27 is a flowchart of migration from an individual virtual world to a multiplayer virtual world according to an exemplary embodiment of this application. In this embodiment, migration from the individual virtual world to the multiplayer virtual worlds can be performed without black screen loading, so that seamless migration can be implemented. A process is as follows:
1-1. Start DS.
2-1. Invoke a network processing interface of Hook UWorld.
1-2. During operation of a single-player mode.
2-2. Attempt to connect to a server.
3. After initialization of the DS is completed, wait for access by a player.
4. After handshake is completed, create an early communication Actor belonging to a client based on a connection.
5. Invoke the early communication Actor to invoke a remote method, and start data synchronization.
6. The client obtains the synchronized early communication Actor, and invokes a method for starting data synchronization.
7. Transmit serialized client data to the server, which is implemented through data synchronization by using a remote invocation method.
8. Receive the client data, and then deserialize the client data to replace data that needs to be created in a character creation process.
9. A normal character creation process.
10. Receive a new Actor object synchronized by the server.
11. Determine, by using NetToken, whether the new Actor object is an object previously serialized by the client.
12. Destroy an object delivered by a network, use an original object, and set networking mark setting of the original object.
13. Rebind an ActorChannel.

In the foregoing embodiment, a backend server can pull up the DS process and complete scene construction. The player can enter the multiplayer virtual world without black screen loading of the client. This realizes seamless switching and seamless migration between different virtual worlds. In addition, the player can be reduced from being interrupted by the black screen loading process in a game, thereby ensuring the fluency of game experience.

FIG. 28 is a structural block diagram of a virtual world-based character interaction apparatus according to an exemplary embodiment of this application. The apparatus 910 includes:
a display module 911, configured to display a first virtual character in a physical state in a first virtual world;
a control module 912, configured to control, in response to a control operation on the first virtual character, the first virtual character to perform physical interaction with a world element in the physical state in the first virtual world;
the display module 911, configured to display a second virtual character in a ghost state in the first virtual world, the second virtual character being a character controlled by a second client in a second virtual world; and
the control module 912, configured to control the first virtual character to perform non-physical interaction with the second virtual character, no physical interaction being performed by the second virtual character with the world element in the first virtual world during the non-physical interaction.

In some embodiments, the control module 912 is configured to:
control, in response to an action cast operation on the first virtual character, the first virtual character to perform a target action in the first virtual world, to enable the second virtual character to observe the target action of the first virtual character, where
the target action includes at least one of a limb action and an expression action.

In some embodiments, the control module 912 is configured to:
display at least two candidate action options corresponding to the first virtual character in response to the action cast operation on the first virtual character; and
control the first virtual character to perform the target action in the first virtual world in response to a selection operation on a target action option in the at least two candidate action options, to enable the second virtual character to observe the target action of the first virtual character.

In some embodiments, the display module 911 is configured to:
display an interactive element in vicinity of the second virtual character, where the interactive element is configured for indicating that the second virtual character has an interaction requirement; and
display the second virtual character in the physical state in response to an agree operation on the interaction requirement.

In some embodiments, the control module 912 is configured to:
control the first virtual character to perform physical interaction with the second virtual character.

In some embodiments, the display module 911 is configured to:
display a chat interactive element in the vicinity of the second virtual character, where the chat interactive element is configured for indicating that the second virtual character has a chat requirement; and
displaying the second virtual character in the physical state and chat content of the second virtual character in response to an agree operation on the chat requirement.

In some embodiments, the control module 912 is configured to:
control the first virtual character to chat with the second virtual character.

In some embodiments, the display module 911 is configured to:
display a team-up interactive element in the vicinity of the second virtual character, where the team-up interactive element is configured for indicating that the second virtual character has a team-up requirement; and
display the first virtual character and the second virtual character that are located in the second virtual world in response to an agree operation on the team-up requirement.

In some embodiments, the control module 912 is configured to:
control the first virtual character and the second virtual character to perform team-up interaction in the second virtual world.

In some embodiments, the display module 911 is configured to:
display a challenge interactive element in the vicinity of the second virtual character, where the challenge interactive element is configured for indicating that the second virtual character has a challenge requirement; and
display the first virtual character and the second virtual character that are located in the second virtual world in response to an agree operation on the challenge requirement.

In some embodiments, the control module 912 is configured to:
control the first virtual character and the second virtual character to perform adversarial interaction in the second virtual world.

In some embodiments, the control module 912 is configured to:
control the first virtual character to move in the first virtual world.

In some embodiments, the display module 911 is configured to:
display the first virtual character and a third virtual character that are in the physical state in response to that the first virtual character moves into a target region of the first virtual world, where the target region is a region allowing different virtual characters to perform physical interaction with a world element in a multiplayer region; and
display the first virtual character in the physical state and canceling display of the third virtual character in the physical state in response to that the first virtual character moves out of the target region of the first virtual world.

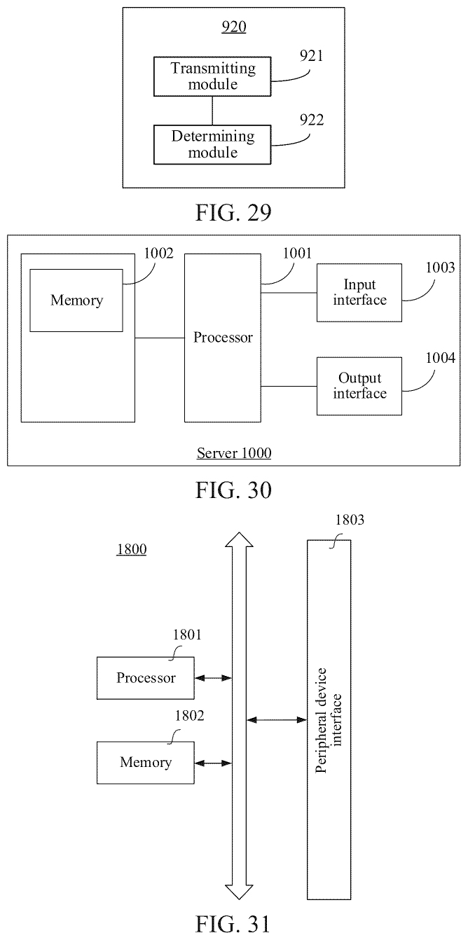

FIG. 29 is a structural block diagram of a virtual world-based character interaction apparatus according to an exemplary embodiment of this application. The apparatus 920 includes:
a transmitting module 921, configured to transmit, when a first virtual character is in an online state, a world element of a first virtual world corresponding to the first virtual character to a first client;
a determining module 922, configured to determine a second virtual character, the second virtual character being a virtual character located in a second virtual world; and
the transmitting module 921, configured to transmit character synchronization data of the second virtual character to the first client, to enable the first client to display the second virtual character in a ghost state in the first virtual world and control the first virtual character to perform non-physical interaction with the second virtual character, no physical interaction being performed by the second virtual character with the world element in the first virtual world during the non-physical interaction.

In some embodiments, the first virtual character and the second virtual character belong to the same character group, and the determining module 922 is configured to:
filter, when a quantity of people of the character group in which the first virtual character is located does not meet a quantity threshold, at least one second virtual character from a free character set according to a filtering condition into the character group, where
the free character set includes virtual characters that do not join any character group, and virtual characters in the same character group are visible to each other or have permission of viewing other virtual characters in respective virtual worlds.

In some embodiments, the filtering condition is related to at least one of the following factors:
whether the first virtual character and the second virtual character have a team-up relationship;
a character attribute or a character attribute value of the first virtual character;
a character attribute or a character attribute value of the second virtual character;
a position of the first virtual character;
a position of the second virtual character;
a field of view of the first virtual character; or
a field of view of the second virtual character.

In some embodiments, the apparatus further includes a splitting module; and the splitting module is configured to:
remove the second virtual character from the character group when the second virtual character meets a removal condition, where
the removal condition includes at least one of: the second virtual character gets offline, a distance between the second virtual character and the first virtual character is greater than a threshold, or the second virtual character forms a team with another virtual character.

In some embodiments, the transmitting module 921 is configured to:
transmit at least one of character movement data, character battle data, character attribute data, character chat data, character action data, or character interaction requirement data of the second virtual character to the first client.

In some embodiments, the apparatus further includes a switching module; and the switching module is configured to:
switch, when the first virtual character moves into a target region of the first virtual world, from a single-player server to a multiplayer server to provide a backend service for the first virtual character, where the target region is a region allowing different virtual characters to perform physical interaction with a world element in a multiplayer region; and
switch, when the first virtual character moves out of the target region of the first virtual world, from the multiplayer server to the single-player server to provide a backend service for the first virtual character.

In some embodiments, the apparatus further includes a loading module; and the loading module is configured to:
load a public map block by the single-player server when the first virtual character is not located in the target region and a distance between the first virtual character and the second virtual character is less than a distance threshold, where the public map block is determined based on a position of the first virtual character and a position of the second virtual character; and
load a first private map block and a second private map block separately by the single-player server when the first virtual character is not located in the target region and the distance between the first virtual character and the second virtual character is greater than the distance threshold, where the first private map block is determined based on the position of the first virtual character, and the second private map block is determined based on the position of the second virtual character.

An embodiment of this application further provides a computer device, including a processor and a memory, the memory having a computer program stored therein; and the processor being configured to execute the computer program stored in the memory to implement the virtual world-based character interaction method according to the foregoing method embodiments.

In some embodiments, the computer device is a server. For example, FIG. 30 is a structural block diagram of a server according to an exemplary embodiment of this application.

Generally, the server 1000 includes a processor 1001 and a memory 1002.

The processor 1001 may include one or more processing cores, for example, a 4-core processor or an 8-core processor. The processor 1001 may be implemented in at least one hardware form of a digital signal processor (DSP), a field-programmable gate array (FPGA), or a programmable logic array (PLA). The processor 1001 may alternatively include a main processor and a coprocessor. The main processor is a processor configured to process data in an awake state, and is also referred to as a central processing unit (CPU). The coprocessor is a low power consumption processor configured to process data in a standby state. In some embodiments, the processor 1001 may be integrated with a graphics processing unit (GPU). The GPU is configured to render and draw content that needs to be displayed on a display screen. In some embodiments, the processor 1001 may further include an artificial intelligence (AI) processor. The AI processor is configured to process computing operations related to machine learning.

The memory 1002 may include one or more computer-readable storage media. The computer-readable storage medium may be non-transient. The memory 1002 may further include a high-speed random access memory and a non-volatile memory, for example, one or more magnetic disk storage devices or flash storage devices. In some embodiments, the non-transient computer-readable storage medium in the memory 1002 is configured to store at least one instruction, and the at least one instruction is configured for being executed by the processor 1001 to implement the virtual world-based character interaction method according to the method embodiments of this application.

In some embodiments, the server 1000 further includes: an input interface 1003 and an output interface 1004. The processor 1001, the memory 1002, the input interface 1003, and the output interface 1004 may be connected to each other through a bus or a signal cable. Each peripheral device may be connected to the input interface 1003 and the output interface 1004 through a bus, a signal cable, or a circuit board. The input interface 1003 and the output interface 1004 may be configured to connect at least one input/output (I/O)-related peripheral device to the processor 1001 and the memory 1002. In some embodiments, the processor 1001, the memory 1002, the input interface 1003, and the output interface 1004 are integrated on the same chip or circuit board. In some other embodiments, any one or two of the processor 1001, the memory 1002, the input interface 1003, and the output interface 1004 may be implemented on a single chip or circuit board. This is not limited in the embodiments of this application.

FIG. 31 is a structural block diagram of a computer device according to an exemplary embodiment of this application. The computer device 1800 may be a portable mobile terminal such as a smartphone, a tablet computer, a Moving Picture experts Group Audio Layer III (MP3) player, or a Moving Picture Experts Group Audio Layer IV (MP4) player. The computer device 1800 may also be referred to as another name such as user equipment or a portable terminal.

Generally, the computer device 1800 includes a processor 1801 and a memory 1802.

The processor 1801 may include one or more processing cores, for example, a 4-core processor or an 8-core processor. The processor 1801 may be implemented in at least one hardware form of a digital signal processor (DSP), a field-programmable gate array (FPGA), or a programmable logic array (PLA). The processor 1801 may alternatively include a main processor and a coprocessor. The main processor is a processor configured to process data in an awake state, and is also referred to as a central processing unit (CPU). The coprocessor is a low power consumption processor configured to process data in a standby state. In some embodiments, the processor 1801 may be integrated with a graphics processing unit (GPU). The GPU is configured to render and draw content that needs to be displayed on a display screen. In some embodiments, the processor 1801 may further include an artificial intelligence (AI) processor. The AI processor is configured to process computing operations related to machine learning.

The memory 1802 may include one or more computer-readable storage media. The computer-readable storage medium may be tangible and non-transient. The memory 1802 may further include a high-speed random access memory and a non-volatile memory, for example, one or more magnetic disk storage devices or flash storage devices. In some embodiments, the non-transient computer-readable storage medium in the memory 1802 is configured to store at least one instruction, and the at least one instruction is configured for being executed by the processor 1801 to implement the virtual world-based character interaction method according to the embodiments of this application.

In some embodiments, the computer device 1800 further includes: a peripheral device interface 1803 and at least one peripheral device. Specifically, the peripheral device includes at least one of a radio frequency (RF) circuit, a touch display screen, a camera, an audio circuit, or a power supply.

The peripheral device interface 1803 may be configured to connect at least one input/output (I/O)-related peripheral device to the processor 1801 and the memory 1802. In some embodiments, the processor 1801, the memory 1802, and the peripheral device interface 1803 are integrated on the same chip or circuit board. In some other embodiments, any one or two of the processor 1801, the memory 1802, and the peripheral device interface 1803 may be implemented on a single chip or circuit board. This is not limited in this embodiment.

In some embodiments, the peripheral device may include a display screen, an audio circuit, a power supply, a sensor, or the like. This is not limited in this embodiment.

A person skilled in the art may understand that the structures shown in FIG. 30 and FIG. 31 do not constitute a limitation to the server 1000 and the computer device 1800. The server or the computer device may include more or fewer components than those shown in the figure, may combine some components, or may use different component arrangements.

In an exemplary embodiment, this application provides a chip. The chip includes a programmable logic circuit and/or program instructions. When the chip is run on a computer device, the chip is configured to implement the virtual world-based character interaction method described above.

This application provides a non-transitory computer-readable storage medium. The computer-readable storage medium has a computer program stored therein, and the computer program is loaded and executed by a processor to implement the virtual world-based character interaction method described above.

This application provides a computer program product or a computer program, including computer instructions, the computer instructions being stored in a computer-readable storage medium. A processor obtains the computer instructions from the computer-readable storage medium, to cause a processor the load and execute the computer instructions to implement the virtual world-based character interaction method described above.

The sequence numbers of the foregoing embodiments of this application are merely for description purpose but do not indicate the preference of the embodiments.

A person of ordinary skill in the art may understand that all or some of the operations of the embodiments may be implemented by hardware or a program instructing relevant hardware. The program may be stored in a computer-readable storage medium. The storage medium may be a read-only memory, a magnetic disk, or an optical disc.

A person skilled in the art is to be aware that in the foregoing one or more examples, functions described in the embodiments of this application may be implemented by hardware, software, firmware, or any combination thereof. When the functions are implemented by software, the foregoing functions may be stored in a computer-readable medium or transmitted as one or more instructions or code in the computer-readable medium. The computer-readable medium includes a computer storage medium and a communication medium, where the communication medium includes any medium that enables a computer program to be transmitted from one place to another. The storage medium may be any available medium accessible to a general-purpose or dedicated computer.

The foregoing descriptions are merely exemplary embodiments of this application, but are not intended to limit this application. Any modification, equivalent replacement, or improvement made within the spirit and principle of this application shall fall within the protection scope of this application.

What is claimed is:

1. A virtual world-based character interaction method performed by a computer device, the method comprising:
displaying a first virtual character in a physical state in a first virtual world;
in response to a first control operation on the first virtual character by a user of the computer device, controlling the first virtual character to perform physical interaction with a world element in the physical state in the first virtual world and updating the world element in the first virtual world in accordance with the physical interaction;
displaying a second virtual character in a ghost state in the first virtual world, the second virtual character being a character in a second virtual world controlled by a second computer device; and
in response to a second control operation on the first virtual character by the user of the computer device, controlling the first virtual character to perform non-physical interaction with the second virtual character, wherein no physical interaction is performed on the second virtual character in the first virtual world and a physical interaction is performed on the second virtual character in the second virtual world during the non-physical interaction.

2. The method according to claim 1, wherein the controlling the first virtual character to perform non-physical interaction with the second virtual character comprises:
in response to an action cast operation on the first virtual character, controlling the first virtual character to perform a target action in the first virtual world and transmitting the target action to the second virtual world to enable the second virtual character to observe the target action of the first virtual character in the second virtual world, wherein
the target action comprises at least one of a limb action and an expression action.

3. The method according to claim 2, wherein the controlling the first virtual character to perform a target action in the first virtual world comprises:
displaying at least two candidate action options corresponding to the first virtual character in response to the action cast operation on the first virtual character; and
controlling the first virtual character to perform the target action in the first virtual world in response to a selection operation on a target action option in the at least two candidate action options, to enable the second virtual character to observe the target action of the first virtual character.

4. The method according to claim 1, further comprising:
displaying an interactive element in vicinity of the second virtual character in the first virtual world, the interactive element being configured for indicating that the second virtual character has an interaction requirement;
changing the second virtual character from the ghost state to the physical state in the first virtual world in response to an agree operation on the interaction requirement; and
controlling the first virtual character to perform physical interaction with the second virtual character.

5. The method according to claim 4, wherein the method further comprises:
displaying a chat interactive element in the vicinity of the second virtual character, wherein the chat interactive element is configured for indicating that the second virtual character has a chat requirement;
displaying the second virtual character in the physical state and chat content of the second virtual character in response to an agree operation on the chat requirement; and
controlling the first virtual character to chat with the second virtual character.

6. The method according to claim 4, wherein the method further comprises:
displaying a team-up interactive element in the vicinity of the second virtual character, wherein the team-up interactive element is configured for indicating that the second virtual character has a team-up requirement;
displaying the first virtual character and the second virtual character that are located in the second virtual world in response to an agree operation on the team-up requirement; and
controlling the first virtual character and the second virtual character to perform team-up interaction in the second virtual world.

7. The method according to claim 4, wherein the method further comprises:
displaying a challenge interactive element in the vicinity of the second virtual character, wherein the challenge interactive element is configured for indicating that the second virtual character has a challenge requirement;
displaying the first virtual character and the second virtual character that are located in the second virtual world in response to an agree operation on the challenge requirement; and
controlling the first virtual character and the second virtual character to perform adversarial interaction in the second virtual world.

8. The method according to claim 1, further comprising:
controlling the first virtual character to move in the first virtual world;
displaying the first virtual character and a third virtual character that are in the physical state in response to that the first virtual character moves into a target region of the first virtual world, the target region being a region allowing different virtual characters to perform physical interaction with a world element in a multiplayer region; and
displaying the first virtual character in the physical state and canceling display of the third virtual character in the physical state in response to that the first virtual character moves out of the target region of the first virtual world.

9. A computer device, comprising a processor and a memory, the memory having a computer program stored therein, and the computer program being loaded and executed by the processor and causing the computer device to implement a virtual world-based character interaction method including:
displaying a first virtual character in a physical state in a first virtual world;
in response to a first control operation on the first virtual character by a user of the computer device, controlling the first virtual character to perform physical interaction with a world element in the physical state in the first virtual world and updating the world element in the first virtual world in accordance with the physical interaction;
displaying a second virtual character in a ghost state in the first virtual world, the second virtual character being a character in a second virtual world controlled by a second computer device; and
in response to a second control operation on the first virtual character by the user of the computer device, controlling the first virtual character to perform non-physical interaction with the second virtual character, wherein no physical interaction is performed on the second virtual character in the first virtual world and a physical interaction is performed on the second virtual character in the second virtual world during the non-physical interaction.

10. The computer device according to claim 9, wherein the controlling the first virtual character to perform non-physical interaction with the second virtual character comprises:
in response to an action cast operation on the first virtual character, controlling the first virtual character to perform a target action in the first virtual world and transmitting the target action to the second virtual world to enable the second virtual character to observe the target action of the first virtual character in the second virtual world, wherein
the target action comprises at least one of a limb action and an expression action.

11. The computer device according to claim 10, wherein the controlling the first virtual character to perform a target action in the first virtual world comprises:
displaying at least two candidate action options corresponding to the first virtual character in response to the action cast operation on the first virtual character; and
controlling the first virtual character to perform the target action in the first virtual world in response to a selection operation on a target action option in the at least two candidate action options, to enable the second virtual character to observe the target action of the first virtual character.

12. The computer device according to claim 9, wherein the method further comprises:
displaying an interactive element in vicinity of the second virtual character in the first virtual world, the interactive element being configured for indicating that the second virtual character has an interaction requirement;
changing the second virtual character from the ghost state to the physical state in the first virtual world in response to an agree operation on the interaction requirement; and
controlling the first virtual character to perform physical interaction with the second virtual character.

13. The computer device according to claim 12, wherein the method further comprises:
displaying a chat interactive element in the vicinity of the second virtual character, wherein the chat interactive element is configured for indicating that the second virtual character has a chat requirement;
displaying the second virtual character in the physical state and chat content of the second virtual character in response to an agree operation on the chat requirement; and
controlling the first virtual character to chat with the second virtual character.

14. The computer device according to claim 12, wherein the method further comprises:
displaying a team-up interactive element in the vicinity of the second virtual character, wherein the team-up interactive element is configured for indicating that the second virtual character has a team-up requirement;
displaying the first virtual character and the second virtual character that are located in the second virtual world in response to an agree operation on the team-up requirement; and
controlling the first virtual character and the second virtual character to perform team-up interaction in the second virtual world.

15. The computer device according to claim 12, wherein the method further comprises:
displaying a challenge interactive element in the vicinity of the second virtual character, wherein the challenge interactive element is configured for indicating that the second virtual character has a challenge requirement;
displaying the first virtual character and the second virtual character that are located in the second virtual world in response to an agree operation on the challenge requirement; and
controlling the first virtual character and the second virtual character to perform adversarial interaction in the second virtual world.

16. The computer device according to claim 9, wherein the method further comprises:
controlling the first virtual character to move in the first virtual world;
displaying the first virtual character and a third virtual character that are in the physical state in response to that the first virtual character moves into a target region of the first virtual world, the target region being a region allowing different virtual characters to perform physical interaction with a world element in a multiplayer region; and
displaying the first virtual character in the physical state and canceling display of the third virtual character in the physical state in response to that the first virtual character moves out of the target region of the first virtual world.

17. A non-transitory computer-readable storage medium, having a computer program stored therein, and the computer program being loaded and executed by a processor of a computer device and causing the computer device to implement a virtual world-based character interaction method including:
displaying a first virtual character in a physical state in a first virtual world;
in response to a first control operation on the first virtual character by a user of the computer device, controlling the first virtual character to perform physical interaction with a world element in the physical state in the first virtual world and updating the world element in the first virtual world in accordance with the physical interaction;
displaying a second virtual character in a ghost state in the first virtual world, the second virtual character being a character in a second virtual world controlled by a second computer device; and
in response to a second control operation on the first virtual character by the user of the computer device, controlling the first virtual character to perform non-physical interaction with the second virtual character, wherein no physical interaction is performed on the second virtual character in the first virtual world and a physical interaction is performed on the second virtual character in the second virtual world during the non-physical interaction.

18. The non-transitory computer-readable storage medium according to claim 17, wherein the controlling the first virtual character to perform non-physical interaction with the second virtual character comprises:
in response to an action cast operation on the first virtual character, controlling the first virtual character to perform a target action in the first virtual world and transmitting the target action to the second virtual world to enable the second virtual character to observe the target action of the first virtual character in the second virtual world, wherein
the target action comprises at least one of a limb action and an expression action.

19. The non-transitory computer-readable storage medium according to claim 18, wherein the controlling the first virtual character to perform a target action in the first virtual world comprises:
displaying at least two candidate action options corresponding to the first virtual character in response to the action cast operation on the first virtual character; and
controlling the first virtual character to perform the target action in the first virtual world in response to a selection operation on a target action option in the at least two candidate action options, to enable the second virtual character to observe the target action of the first virtual character.

20. The non-transitory computer-readable storage medium according to claim 17, wherein the method further comprises:
displaying an interactive element in vicinity of the second virtual character in the first virtual world, the interactive element being configured for indicating that the second virtual character has an interaction requirement;
changing the second virtual character from the ghost state to the physical state in the first virtual world in response to an agree operation on the interaction requirement; and
controlling the first virtual character to perform physical interaction with the second virtual character.
